(19) United States
(12) Patent Application Publication
(10) Pub. No.: US 2018/0021886 A1
(43) Pub. Date: Jan. 25, 2018

(54) LASER MACHINING APPARATUS WITH WORKPIECE POSITION ADJUSTING CAPABILITY RELATIVE TO FOCAL POINT OF LASER BEAM

(71) Applicant: BROTHER KOGYO KABUSHIKI KAISHA, Nagoya-shi (JP)

(72) Inventors: Kousuke USHIRODA, Nagoya (JP); Yasuo NISHIKAWA, Nagoya (JP)

(21) Appl. No.: 15/720,354

(22) Filed: Sep. 29, 2017

Related U.S. Application Data
(63) Continuation of application No. PCT/JP2016/071818, filed on Jul. 26, 2016.

(30) Foreign Application Priority Data
Jul. 31, 2015 (JP) 2015-151654

(51) Int. Cl. B23K 26/046; B23K 26/36; B23K 26/352; B23K 26/00; B23K 26/08; B23K 26/064

(52) U.S. Cl. CPC B23K 26/046; B23K 26/083; B23K 26/064; B23K 26/352; B23K 26/0066; B23K 26/36

(57) ABSTRACT

In a laser machining apparatus, an optical member converges a laser beam for machining a workpiece disposed on a mounting surface perpendicular to a first direction and maintains a focal point of the converged laser beam in a focal plane located at a focal position in the first direction. A visible light irradiating device irradiates a visible light in the first direction, thereby projecting a focus target on the workpiece. A pointer beam emitting device emits a pointer beam toward the mounting surface at a prescribed inclination angle. A controller is configured to perform: modifying a positional relationship between the focus target and the pointer beam in a second direction perpendicular to the first direction according to position information related to a projecting position of one of the focus target and the pointer beam in the first direction; and projecting the focus target and the pointer beam onto the workpiece.

### CROSS REFERENCE TO RELATED APPLICATION

This application is a by-pass continuation of International Application No. PCT/JP2016/071818 filed Jul. 26, 2016 claiming priority from Japanese Patent Application No. 2015-151654 filed Jul. 31, 2015. The entire content of the priority application and the international application are incorporated herein by reference.

### TECHNICAL FIELD

The present disclosure relates to a laser machining apparatus that machines a surface of a workpiece by irradiating a laser beam thereon.

### BACKGROUND

A conventional laser machining apparatus is configured to machine a workpiece by irradiating a laser beam thereon. The irradiated laser beam is progressively scanned to irradiate desired positions on the workpiece placed on a mounting unit in order to machine patterns depicting characters, symbols, and the like.

In order to accurately machine a workpiece with this conventional laser machining apparatus, an operation to adjust the position of the workpiece must be performed prior to machining the workpiece with the laser beam. The operation requires that the workpiece be placed in a prescribed position on the mounting unit (a desired position within a plane, for example) at which the workpiece can be scanned with the laser beam scanning system. In addition, the mounting unit must be adjusted vertically until the surface of the workpiece is moved to a position corresponding to the focal point of the laser beam.

The laser marking apparatus disclosed in Japanese Patent Application Publication No. 2005-103614 has a laser light source, galvano mirrors, a converging lens, a visible light source used as a guide, and a light source for producing a visible light spot. Marking is performed on the workpiece with this conventional laser marking apparatus using the galvano mirrors to scan a marking laser beam emitted from the laser light source.

The conventional laser marking apparatus described above scans a guide beam emitted from the guiding visible light source over the workpiece to project reference scale marks onto the workpiece for indicating the spot diameter of the marking laser beam. At the same time, visible light obliquely irradiated from the light source for the visible light spot moves as the distance separating the converging lens and the workpiece is adjusted. With this laser marking apparatus, the spot diameter for marking can be determined on the basis of the projected position of the visible light spot and the graduations in the reference scale marks.

### SUMMARY

However, since the laser marking apparatus described above is configured to project reference scale marks onto the workpiece by scanning the guide beam emitted from the guiding visible light source over the workpiece with the galvano mirrors, it is difficult to visualize all reference scale marks at all times. In most cases, only some of the reference scale marks are visible. It is particularly difficult when the reference scale marks are configured of multiple line segments, as in the above described example. In such cases, only a few of the line segments are visible at any time while most of the line segments do not appear.

Since the reference scale marks are used by the laser marking apparatus described above as reference for adjusting the distance between the converging lens and the workpiece and the spot diameter of the laser beam, such precise positional adjustments are difficult to perform when visibility of the reference scale marks is poor. Further, modifying the distance between the converging lens and the workpiece through defocusing can change the lengths of the line segments constituting the reference scale marks, making it more difficult to perform precise positional adjustments.

With the construction of the laser marking apparatus described above, it is not always advisable to align the focal point of the laser beam with the surface of the workpiece, depending on the composition of the workpiece and the type of process being performed. In other words, it is sometimes better to offset the focal point of the laser beam vertically when performing marking operations. Here, since the laser marking apparatus described above is unable to change the projected position of the reference scale marks, the apparatus cannot perform accurate positional adjustments at a desired vertical position offset from the focal point of the laser beam.

In view of the foregoing, it is an object of the present disclosure to provide a laser machining apparatus that machines the surface of a workpiece by irradiating a laser beam thereon and that is capable of improving the precision and convenience of operations for vertically adjusting the position of the workpiece relative to the focal point of the laser beam.

In order to attain the above and other objects, the present disclosure provides an laser machining apparatus including: a laser beam emitting device; a scanner; an optical member; a visible light irradiating device; a pointer beam emitting device; an input device; and a controller. The laser beam emitting device is configured to emit a laser beam for machining a workpiece disposed on a mounting surface perpendicular to a first direction. The scanner is configured to scan the laser beam emitted from the laser beam emitting device. The optical member is configured to converge the laser beam scanned by the scanner and maintain a focal point of the converged laser beam in a focal plane perpendicular to the first direction. The focal plane is located at a focal position in the first direction. The visible light irradiating device is configured to irradiate a visible light in the first direction, thereby projecting a focus target on the workpiece. The pointer beam emitting device is configured to emit a pointer beam toward the mounting surface at a prescribed inclination angle relative to the first direction. The pointer beam and the focus target are used for adjusting the focal position of the laser beam relative to the workpiece. The input device is configured to receive position information related to a projecting position of one of the focus target and the pointer beam in the first direction. The controller is configured to perform: modifying a positional relationship between the focus target and the pointer beam in a second direction perpendicular to the first direction according to the position information; and projecting the focus target and the pointer beam onto the workpiece.

According to another aspect, the present disclosure provides a non-transitory computer readable storage medium storing a set of program instructions for a laser machining apparatus. The laser machining apparatus includes: a laser beam emitting device; a scanner; an optical member; a visible light irradiating device; a pointer beam emitting device; an input device; and a controller. The laser beam emitting device is configured to emit a laser beam for machining a workpiece disposed on a mounting surface perpendicular to a first direction. The scanner is configured to scan the laser beam emitted from the laser beam emitting device. The optical member is configured to converge the laser beam scanned by the scanner and maintain a focal point of the converged laser beam in a focal plane perpendicular to the first direction. The focal plane is located at a focal position in the first direction. The visible light irradiating device is configured to irradiate a visible light in the first direction, thereby projecting a focus target on the workpiece. The pointer beam emitting device is configured to emit a pointer beam toward the mounting surface at a prescribed inclination angle relative to the first direction. The pointer beam and the focus target are used for adjusting the focal position of the laser beam relative to the workpiece. The input device is configured to receive position information related to a projecting position of one of the focus target and the pointer beam in the first direction. The set of program instructions, when executed by the controller, causes the laser machining apparatus to perform: modifying a positional relationship between the focus target and the pointer beam in a second direction perpendicular to the first direction according to the position information; and projecting the focus target and the pointer beam onto the workpiece.

### BRIEF DESCRIPTION OF THE DRAWINGS

The particular features and advantages of the disclosure as well as other objects will become apparent from the following description taken in connection with the accompanying drawings, in which:

FIG. 1 is a schematic view of a laser machining apparatus according to one embodiment of the present disclosure;

FIG. 2 is a perspective view showing an external appearance of a laser machining unit in the laser machining apparatus according to the embodiment;

FIG. 3 is a plan view showing a structure of a laser head unit in the laser machining apparatus according to the embodiment;

FIG. 4 is a block diagram showing a configuration of a control system in the laser machining apparatus according to the embodiment;

FIG. 5 is a flowchart illustrating steps in a main process implemented by a main process program executed on a personal computer (PC) in the laser machining apparatus according to the embodiment;

FIG. 6 is a flowchart illustrating steps in a first focus target setting process executed on the PC in the laser machining apparatus according to the embodiment;

FIG. 7 is an explanatory diagram showing an example of a surface condition input window;

FIG. 8 is an explanatory diagram showing an example of a focal position set for a stepped surface drawing mode;

FIG. 9 is an explanatory diagram showing an example of a focal position set for a curved surface drawing mode;

FIG. 10 is an explanatory diagram illustrating a relationship between a projecting position of a focus target and a defocusing amount;

FIG. 11 is a flowchart illustrating steps in a second focus target setting process executed on the PC in the laser machining apparatus according to the embodiment;

FIG. 12 is a flowchart illustrating steps in a fine adjustment setting process executed on the PC in the laser machining apparatus according to the embodiment;

FIG. 13 is an explanatory diagram illustrating display examples of the focus target in the fine adjustment setting process;

FIG. 14 is an explanatory diagram illustrating a relationship between the projecting position of the focus target, and a defocusing amount and an adjustment allowance;

FIG. 15 is a flowchart illustrating steps in a target display modifying process executed on the PC in the laser machining apparatus according to the embodiment;

FIG. 16 is an explanatory diagram illustrating modification of a shape of the focus target; and

FIG. 17 is an explanatory diagram illustrating projecting positions of the focus target and an optical focus guide.

### DETAILED DESCRIPTION

An embodiment in which a laser machining apparatus according to the present disclosure is embodied as a laser machining apparatus 100 will be described while referring to the accompanying drawings wherein like parts and components are designated by the same reference numerals to avoid duplicating description.

(Schematic Configuration of Laser Machining Apparatus)

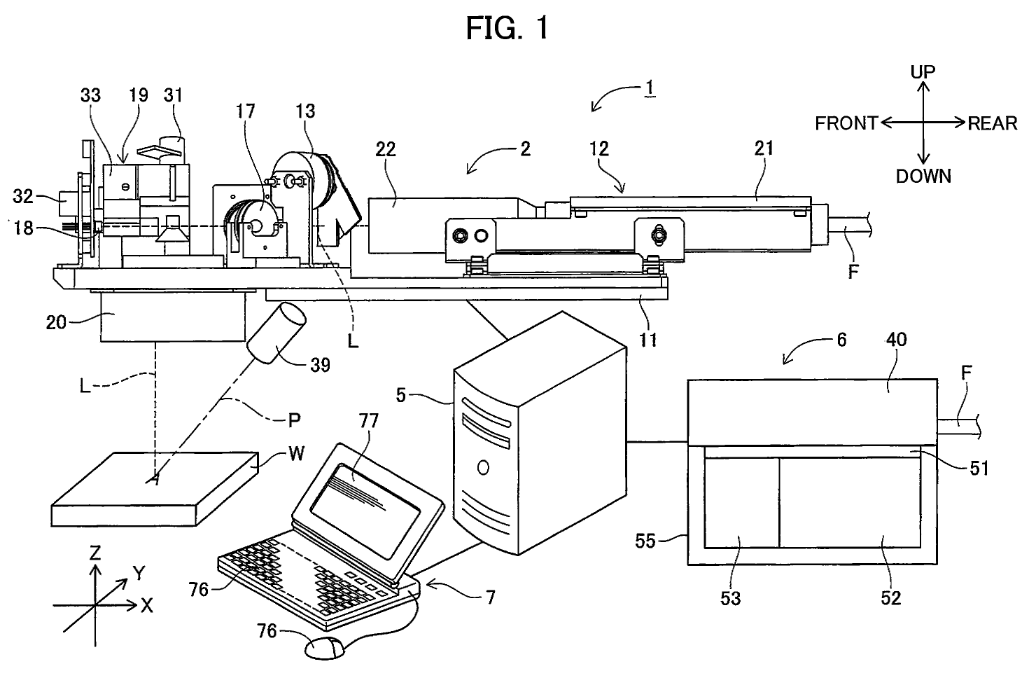

Firstly, the schematic configuration of the laser machining apparatus 100 according to the present embodiment will be explained in detail with reference to FIG. 1. The laser machining apparatus 100 includes a laser machining unit 1 and a personal computer (PC) 7. The laser machining apparatus 100 is configured to control the laser machining apparatus 1 according to drawing data generated by the PC 7, thereby performing marking operations in which a laser beam L scans a surface of a machining target (workpiece W, for example) two dimensionally.

Note that the workpiece W served as the workpiece according to the present embodiment is not limited to a machining target having a planar surface but also includes a machining target having different height levels (such as a machining target having a stepped surface and a machining surface having a curved surface).

(Schematic Configuration of Laser Machining Unit)

Next, the schematic configuration of the laser machining unit 1 of the laser machining apparatus 100 will be described in detail with reference to the drawings. As illustrated in FIG. 1, the laser machining unit 1 according to the present embodiment includes a laser machining main unit 2, a laser controller 5, and a power unit 6.

The laser machining main unit 2 irradiates the laser beam L onto the surface of the workpiece W and performs two-dimensional scan of the laser beam L on the surface of the workpiece W, thereby performing marking on the surface of the workpiece W. The laser controller 5 is configured of a computer, and is connected to the PC 7 so as to be capable of performing bi-directional communications therebetween. The laser controller 6 is also electrically connected to the laser machining main unit 2 and the power unit 6. The PC 7 is used for generating drawing data for performing marking on the surface of the workpiece W (drawing object, for example), for assisting in adjusting a position of the workpiece W to be described later, and the like. The laser controller 5 drives and controls the laser machining main unit 2 and the power unit 6 according to the drawing data, control parameters, and various instructions.

Note that FIG. 1 illustrates only the schematic configuration of the laser machining apparatus 100 and the laser machining unit 1, thus the laser machining main unit 2 is also schematically illustrated in FIG. 1. Therefore, the specific configuration of the laser machining main unit 2 will be described later.

(Schematic Configuration of Laser Machining Main Unit)

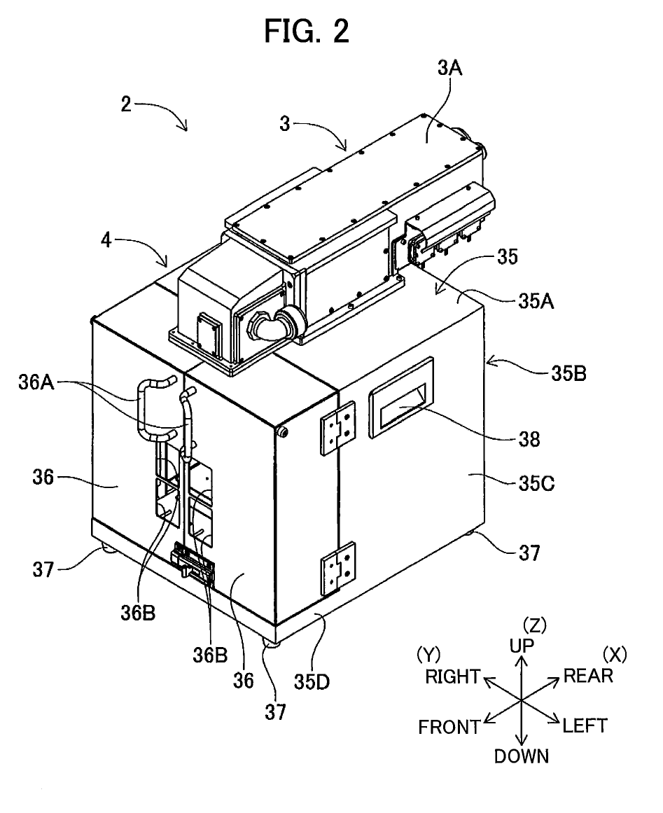

Next, the schematic configuration of the laser machining main unit 2 will be described with reference to FIGS. 1 and 2. In the description about the laser machining main unit 2, the front, rear, up, down indicated by arrows illustrated in FIG. 1 respectively correspond to frontward, rearward, upward, and downward of the laser machining main unit 2. Further, the left and right indicated by arrows illustrated in FIG. 2 respectively correspond to leftward and rightward of the laser machining main unit 2. Thus, the emitting direction of the laser beam L from a laser oscillator 21 (described later) is the frontward direction. Also, in the direction perpendicular to both a main base 11 (described later) and the laser beam L is the upward/downward directions. Further, the direction perpendicular to both the upward/downward directions and frontward/rearward directions is the leftward/rightward directions of the laser machining main unit 2.

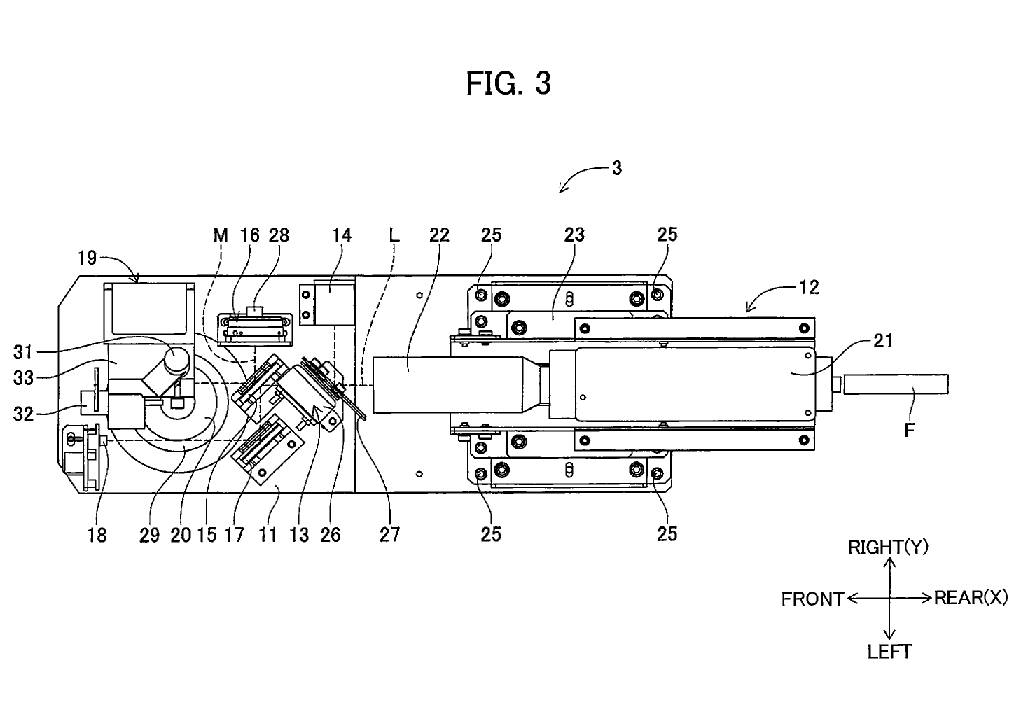

The laser machining main unit 2 includes a laser head unit 3 coaxially emitting the laser beam L and a visible laser beam M from an fθ lens 20, and a substantially box-shaped machining chamber 4 having an upper surface on which the laser head unit 3 is fixed (see FIGS. 2 and 3).

As illustrated in FIG. 3, the laser head unit 3 includes the main base 11, a laser oscillation unit 12 configured to emit a laser beam L, a light shutter 13, a light damper 14, a half mirror 15, a guide optical section 16, a reflection mirror 17, an optical sensor 18, a galvano scanner 19, and the fθ lens 20. The laser head unit 3 is housed in a substantially cuboid-shaped housing 3A (see FIG. 2).

The laser oscillation unit 12 includes the laser oscillator 21, a beam expander 22, and a mounting base 23. The laser oscillator 21 has a fiber connector, a condenser lens, a reflection mirror, a laser medium, a passive Q-switch, an output coupler, and a window, which are accommodated in a casing. The power unit 6 has a semiconductor laser pumping unit 40. The fiber connector is in optical communication with an optical fiber F. Pump light emitted from the semiconductor laser pumping unit 40 is incident upon the fiber connector via the optical fiber F.

The condenser lens concentrates the pump light incident from the fiber connector. The reflection mirror allows the pump light concentrated by the condenser lens to pass therethrough and simultaneously reflects a laser beam emitted from the laser medium at high efficiency. The laser medium is pumped by the pump light emitted from the semiconductor laser pumping unit 40 to oscillate the laser beam. For example, neodymium doped gadolinium vanadate (Nd:GdVO4) crystal to which neodymium (Nd) is doped as a laser active ion, neodymium doped yttrium vanadate (Nd:YVO4) crystal, and neodymium doped yttrium aluminum garnet (Nd:YAG) crystal may be used as the laser medium.

The passive Q-switch is crystal having properties that a penetration rate becomes a value from 80% to 90% when optical energy stored therein exceeds a certain value. Thus, the passive Q-switch functions as a Q-switch for oscillating the laser beam oscillated from the laser medium as a pulsed laser having a pulse shape. For example, chrome doped YAG (Cr:YAG) crystal and Cr:MgSiO4 crystal may be used as the passive Q-switch.

The output coupler constitutes the reflection mirror and a laser resonator. The output coupler is, for example, a partial reflection mirror configured of a concave mirror having a surface coated with a dielectric layer film. The partial reflection mirror has a reflection rate from 80% to 95% in a wavelength of 1064 nm. The window is formed of synthetic silica or the like, and allows the laser beam emitted from the output coupler to pass therethrough outwardly. Thus, the laser oscillator 21 oscillates the pulsed laser through the passive Q-switch, and outputs the pulsed laser as the laser beam L for performing marking on the surface of the workpiece W.

The beam expander 22 changes a beam diameter of the laser beam L, and is attached in coaxial relation to the axis of the laser oscillator 21. The laser oscillator 21 is mounted on the mounting base 23 so as to be capable of adjusting an optical axis of the laser beam L. The mounting base 23 is fixed by each mounting screw 25 at a position rearward from the center position in the frontward/rearward directions with respect to the upper surface of the main base 11.

The light shutter 13 includes a shutter motor 26, and a shutter 27 having a plate shape. The shutter motor 26 is configured of, for example, a stepping motor or the like. The shutter 27 is attached to a motor shaft of the shutter motor 26, and coaxially rotates with the same. When the shutter 27 is rotated at a position where an optical path of the laser beam L emitted from the beam expander 22 is blocked, on one hand, the shutter 27 reflects the laser beam L toward the light damper 14 which is located on the right side of the light shutter 13. When the shutter 27 is rotated at a position out of the optical path of the laser beam L emitted from the beam expander 22, on the other hand, the laser beam L emitted from the beam expander 22 is incident upon the half mirror 15 which is located in front of the light shutter 13.

The light damper 14 absorbs the laser beam L reflected off the shutter 27. Heat generation of the light damper 14 is transferred to the main base 11 and thus the light damper 14 is cooled. The half mirror 15 is disposed so that the surface of the half mirror 15 is oriented in diagonally frontward left direction to form 45 degrees with respect to the optical path of the laser beam L. The half mirror 15 allows substantially all the laser beam L incident into the rear side of the half mirror 15 to pass therethrough. A part of the laser beam L incident into the rear side of the half mirror 15 is reflected at 45 degrees so as to be directed toward the reflection mirror 17. The reflection mirror 17 is disposed at a left-side position relative to the central portion on the rear surface of the half mirror 15 upon which the laser beam L is incident.

The guide optical section 16 includes a visible semiconductor laser 28 and a lens array (not shown). The visible semiconductor laser 28 irradiates the visible laser beam M, such as a red laser beam, and the lens array collimates the visible laser beam M emitted from the visible semiconductor laser 28 into a parallel beam. The visible laser beam M has a wave length different from that of the laser beam L irradiated from the laser oscillator 21, and is used for projecting a focus target T and an optical focus guide G to be described later. The guide optical section 16 is disposed at a right-side position relative to the central portion of the front surface of the half mirror 15 from which the laser beam L is emitted. As a result, the visible laser beam M is incident upon the central portion of the reflection surface of the half mirror 15, from which the laser beam L is emitted, with an incident angle of 45 degrees with respect to the reflection surface of the half mirror 15 which is the front surface of the half mirror 15. Then, the visible laser beam M is reflected upon the reflection surface of the half mirror 15 with a reflection angle of 45 degrees and advances along the optical path of the laser beam L. That is, the visible semiconductor laser 38 irradiates the visible laser beam M along the optical path of the laser beam L.

The reflection mirror 17 is disposed in the optical path of the laser beam L in an orientation to face diagonally frontward left direction to form 45 degrees relative to the frontward direction parallel to the optical path. A part of the laser beam L reflected upon the rear surface of the half mirror 15 is incident upon the central portion of the reflection surface of the reflection mirror 17 at an incident angle of 45 degrees. The reflection mirror 17 directs the laser beam L incident upon the reflecting surface of the reflection mirror 17 in the frontward direction at a reflection angle of 45 degrees.

The optical sensor 18 is configured of a photodiode capable of detecting emission intensity of the laser beam L and the like. As illustrated in FIG. 3, the optical sensor 18 is disposed at a front-side position of the reflection mirror 17 so as to receive the laser beam L emitted from the central portion of the reflection mirror 17 upon which the laser beam L is reflected. With such a positional relationship between the reflection mirror 17 and the optical sensor 18, the emission intensity of the laser beam L can be detected. In this manner, the emission intensity of the laser beam L emitted from the laser oscillator 21 can be detected with the optical sensor 18.

The galvano scanner 19 is mounted above a through-hole 29 formed in the front end portion of the main base 11. The galvano scanner 19 directs the laser beam L emitted from the laser oscillation unit 12 and the visible laser beam M reflected off the half mirror 15 downward through the through-hole 29 and performs two-dimensional scan. The galvano scanner 19 is configured of a galvano X-axis motor 31 having a galvano X-axis mirror, a galvano Y-axis motor 32 having a galvano Y-axis mirror, and a main unit 33. The galvano X-axis motor 31 and the galvano Y-axis motor 32 are mounted and retained in the main unit 33 by being fitted into respective mounting holes from the outside thereof, so that the motor shafts of the galvano X-axis motor 31 and the galvano Y-axis motor 32 are orthogonal to each other.

The galvano X-axis mirror is mounted on a distal end of the motor shaft in the galvano X-axis motor 31 as a scanning mirror. The galvano X-axis mirror is used for scanning the laser beam L and the visible laser beam M in an X-direction within a machining region RM on the surface of the workpiece W. The galvano Y-axis mirror is mounted on a distal end of the motor shaft in the galvano Y-axis motor 32 as a scanning mirror. The galvano Y-axis mirror is used for scanning the laser beam L and the visible laser beam M reflected off the galvano X-axis mirror in a Y-direction within the machining region RM on the surface of the workpiece W.

Hence, the inside surfaces of the scanning mirrors mounted on the distal ends of the motor shafts in the corresponding galvano X-axis motor 31 and galvano Y-axis motor 32 oppose each other in the galvano scanner 19. By controlling the rotations of the galvano X-axis motor 31 and the galvano Y-axis motor 32 in order to rotate each of the respective galvano X-axis mirror and galvano Y-axis mirror, the scanning mirrors scan the laser beam L and the visible laser beam M downward two-dimensionally. These two-dimensional scanning directions include the frontward/rearward directions (X-direction) and the leftward/rightward directions (Y-direction) within the machining region RM on the surface of the workpiece W.

The fθ lens 20 is replaceably mounted beneath the through-hole 29 formed in the front end portion of the main base 11. The fθ lens 20 focuses the laser beam L and the visible laser beam M scanned two-dimensionally by the galvano scanner 19 along the same optical axis toward the surface of the workpiece W disposed below the fθ lens 20. The fθ lens 20 maintains a focal point of the converged laser beam L, the visible laser beam M, or the like in a focal plane, and corrects the scanning speed of the laser beam L and the visible laser beam M to a constant linear speed. Hence, by controlling the rotations of the galvano X-axis motor 31 and the galvano Y-axis motor 32, the fθ lens 20 can scan the laser beam L and the visible laser beam M two-dimensionally in the frontward/rearward directions (the X-direction in FIG. 3) and the leftward/rightward directions (the Y-direction in FIG. 3) according to a desired machining pattern over the surface of the workpiece W.

The fθ lens 20 has an inherent depth of field DF and can perform marking by focusing the laser beam L within this depth of field DF. In other words, the fθ lens 20 is the optical member in the present disclosure, functioning as a converging lens. The depth of field DF in the present disclosure denotes the process range in which machining is possible.

Next, the schematic configuration of the machining chamber 4 will be described with reference to FIG. 2. As illustrated in FIG. 2, the machining chamber 4 is configured of a box-like main enclosure 35 that is open on the front side, two doors 36 that cover the opening in the front side of the main enclosure 35 and that are capable of opening thereon, a mounting unit (not shown) for supporting a workpiece W, and the like. The mounting unit is disposed inside the main enclosure 35 of the machining chamber 4 and is capable of moving vertically (i.e., along the Z-direction). The top surface of the mounting unit has a flat shape that extends along the X-direction and the Y-direction and can support a workpiece W. Thus, when the laser beam L and the visible laser beam M described above pass through the fθ lens 20, the laser beams are irradiated perpendicular to the top surface of the mounting unit. By controlling movement of the mounting unit through the laser controller 5, the laser machining apparatus 100 can adjust the focal point of the laser beams relative to the workpiece W resting on the mounting unit.

The main enclosure 35 and the doors 36 are formed of a material such as steel or stainless steel that blocks light from the laser beam L reflected off the workpiece W. The main enclosure 35 is configured of a generally rectangular top plate part 35A on which the laser head unit 3 is disposed, a rectangular rear plate part 35B forming an inner back part, two rectangular side plate parts 35C forming left and right wall parts, and a bottom part 35D having a square frame-like structure. The bottom part 35D is configured to protrude approximately 30 cm frontward from the side plate parts 35C, for example. Hence, the main enclosure 35 has an open area formed in the front side thereof and above the portion of the bottom part 35D that protrudes frontward from the side plate parts 35C.

The doors 36 are assembled to the main enclosure 35 so as to cover the open area formed in the front side of the main enclosure 35. The doors 36 have left-right symmetry and can open via hinges about rotational axes on the front edge portions of the corresponding side plate parts 35C. The doors 36 can rotate open to an angle of approximately 180 degrees toward the corresponding outer leftward and rightward directions. A handle 36A having a general squared U-shape is attached to the front of each door 36 near the corresponding inner top corner thereof. A pair of square transparent holes 36B is formed beneath each handle 36A, with the transparent holes 36B of each pair arranged vertically adjacent to each other. Each transparent holes 36B is closed by a transparent plate formed of a transparent glass, acrylic plate, or the like that transmits visible light.

The machining chamber 4 also has foot members 37. The foot members 37 are disposed on the bottom surface of the bottom part 35D constituting the main enclosure 35 in each of the four corners thereof. Accordingly, the laser head unit 3 and the machining chamber 4 rest on a floor or other surface via the foot members 37. In addition, a grip member 38 is provided in each of the left and right side plate parts 35C near the top edges thereof. The grip members 38 are embedded in the approximate front-rear center region of the corresponding side plate parts 35C. A portion of each grip member 38 is depressed inward to form a rectangular opening that is elongated horizontally. Accordingly, the user can carry the laser head unit 3 and the machining chamber 4 by gripping the grip members 38.

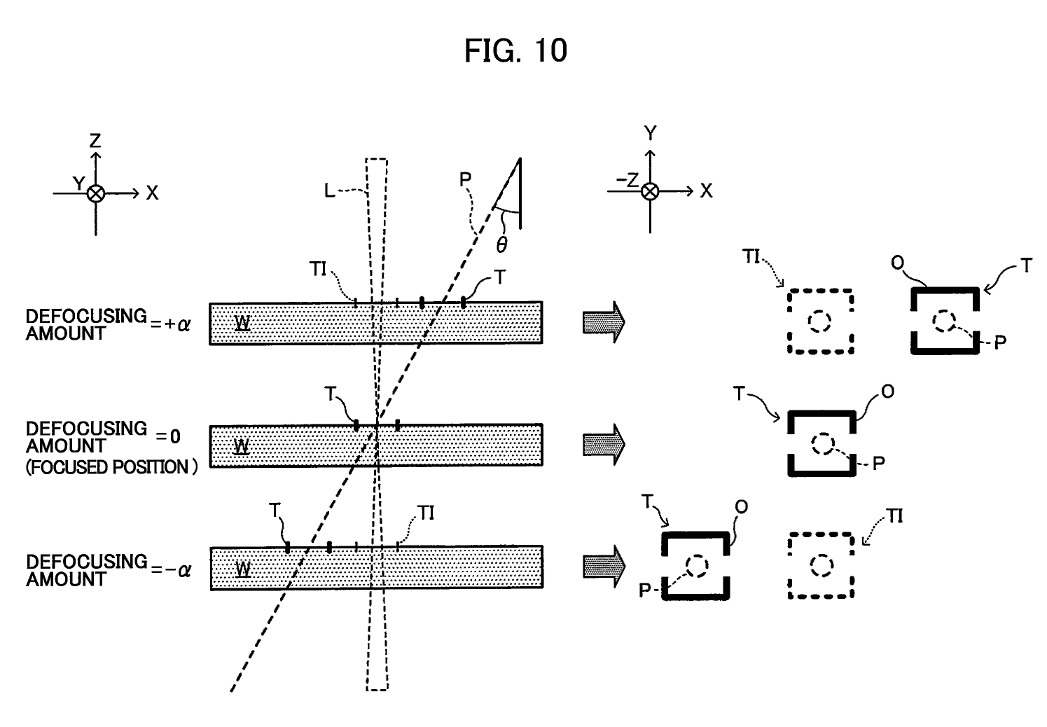

A pointer beam emitting unit 39 (see FIG. 1) is arranged on the laser head unit 3. The pointer beam emitting unit 39 emits a pointer beam P toward the focal point (focused position) of the laser beam L converged by the fθ lens 20. The pointer beam emitting unit 39 is disposed in the inner top region of the main enclosure 35 and is inclined downward toward the mounting unit at a prescribed inclination angle θ from the Z-direction, which is orthogonal to the surface of the mounting unit (see FIG. 10 and the like). The pointer beam emitting unit 39 emits the pointer beam P so as to intersect the laser beam L at a point that the focal point of the laser beam L is aligned with a point of origin in the X-direction and the Y-direction defined relative to the mounting unit (see FIG. 1). More specifically, as illustrated in FIG. 10 and other drawings, the pointer beam emitting unit 39 emits the pointer beam P in a direction inclined at the inclination angle θ, so as to move farther in the −X-direction while progressing downward toward the mounting unit.

(Schematic Configuration of Power Unit)

Next, the schematic configuration of the power unit 6 in the laser machining apparatus 1 will be described with reference to FIG. 1. As illustrated in FIG. 1, the power unit 6 includes the semiconductor laser pumping unit 40, a laser driver 51, a power supply part 52, and a cooling unit 53, which are provided in a casing 55. The power supply part 52 supplies a drive current for driving the semiconductor laser pumping unit 40 to the semiconductor laser pumping unit 40 through the laser driver 51. The laser driver 51 drives the semiconductor laser pumping unit 40 by DC drive according to laser driving data inputted from the laser controller 5.

The semiconductor laser pumping unit 40 is optically connected to the laser oscillator 21 through the optical fiber F. When a pulse-shaped drive current is inputted from the laser driver 51, the semiconductor laser pumping unit 40 injects, into the optical fiber F, the pump light as a laser beam having a wavelength corresponding to the output proportional to a current value exceeding a current threshold at which a laser beam is generated. Thus, the pump light from the semiconductor laser pumping unit 40 is injected into the laser oscillator 21 via the optical fiber F. For example, a bar-type semiconductor laser using the GaAs may be used as the semiconductor laser pumping unit 40.

The cooling unit 53 is provided for keeping the temperature of the power supply part 52 and the semiconductor laser pumping unit 40 within a prescribed range. The cooling unit 53 controls the temperature of the semiconductor laser pumping unit 40 by, for example, an electron cooling system to finely adjust an oscillation wavelength of the semiconductor laser pumping unit 40. Moreover, a cooling unit using a water-cooled system or an air-cooled system may be used as the cooling unit 53.

(Control System of Laser Machining Unit)

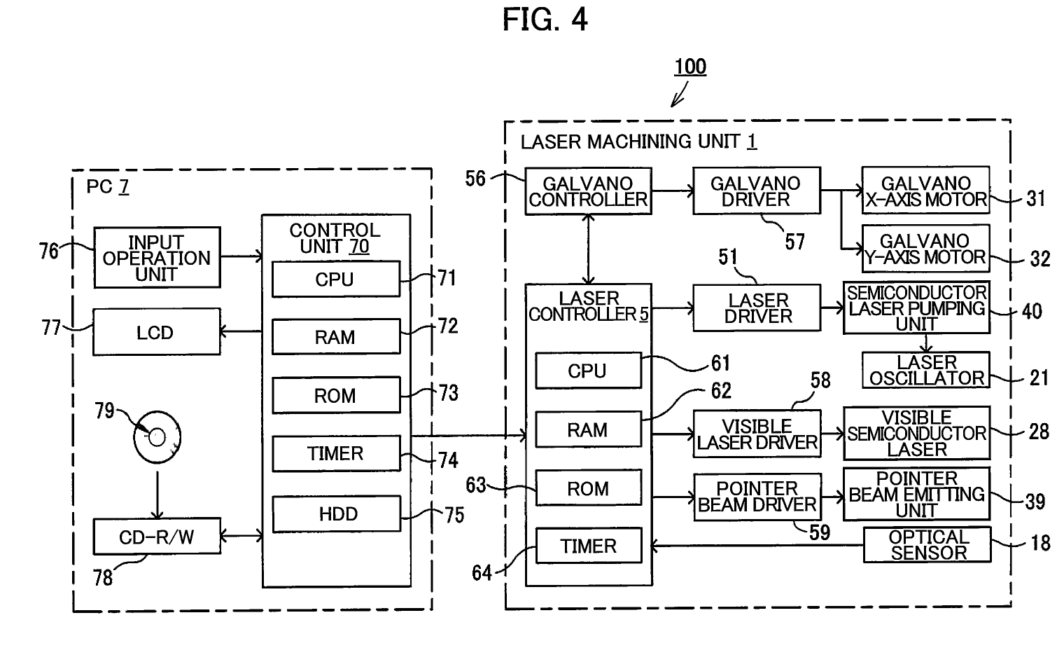

Next, the configuration of the control system of the laser machining unit 1 constituting the laser machining apparatus 100 will be described with reference to the drawings. As illustrated in FIG. 4, the laser machining unit 1 includes the laser controller 5 for governing overall operations of the laser machining unit 1, the laser driver 51, a galvano controller 56, a galvano driver 57, a visible laser driver 58, a pointer beam driver 59, and the like. The laser controller 5 is in electrical communication with the laser driver 51, the galvano controller 56, the optical sensor 18, the visible laser driver 58, the pointer beam driver 59, and the like.

The laser controller 5 includes a central processing unit (CPU) 61, a random access memory (RAM) 62, a read-only memory (ROM) 63, a timer 64, and the like. The CPU 61 is provided as an arithmetic device and a control device for governing overall operations of the laser machining unit 1. The timer 64 is provided for measuring time. The CPU 61, the RAM 62, the ROM 63, and the timer 64 are interconnected via a bus line (not shown), and are in data communication with one another.

The RAM 62 temporarily stores various results of arithmetic operations performed by the CPU 61, X- and Y-coordinate data of a drawing pattern (X- and Y-coordinate data for each points constituting a machining object, for example), and the like. The ROM 63 stores various kinds of programs including a program for performing arithmetic operations to obtain X- and Y-coordinate data of a drawing pattern according to drawing data transmitted from the PC 7 to store the X- and Y-coordinate data in the RAM 62. Specifically, drawing data inputted from the PC 7 represents images defined by positional information. A set of consecutive points derived from the positional information are treated as either a single straight line or an elliptic segment curved line, and X- and Y-coordinate data for each of such lines is obtained to define a drawing pattern. The ROM 63 stores data regarding start point, end point, focal point, and curvature of each elliptic segment curved line that constitute a character with one of a plurality of fonts. Such data is stored in the ROM 43 on a font basis.

The CPU 61 executes various arithmetic and control processes according to the control programs stored in the ROM 63. For example, the CPU 61 receives drawing data from the PC 7 and computes X- and Y-coordinate data, galvano scanning speed data, and the like. Then, the CPU 61 outputs the resultant data to the galvano controller 56. Further, the CPU 61 outputs laser driving data for the semiconductor laser pumping unit 40 to the laser driver 51. The laser driving data relates to output light intensity of pump light from the semiconductor laser pumping unit 40, a time duration of outputting the pump light, and the like set according to drawing data inputted from the PC 7. Also, the CPU 61 outputs the X- and Y-coordinate data of the drawing pattern, a control signal for instructing ON/OFF of the galvano scanner 19 and the like to the galvano controller 56.

The laser driver 51 drives and controls the semiconductor laser pumping unit 40 according to the laser driving data related to the output light intensity of the pump light of the semiconductor laser pumping unit 40, the time duration of outputting the pump light, and the like inputted from the laser controller 5. Specifically, the laser driver 51 generates a pulse-shaped drive current having a current value proportional to the output light intensity of the pump light indicated by the laser driving data inputted from the laser controller 5, and outputs the pulse-shaped drive current to the semiconductor laser pumping unit 40 for an output time duration in accordance with the time duration of outputting the pump light indicated by the laser driving data. Thus, the semiconductor laser pumping unit 40 emits the pump light having intensity corresponding to the output light intensity of the pump light into the optical fiber F for the output time duration.

The galvano controller 56 computes driving angles and rotational speeds of both the galvano X-axis motor 31 and the galvano Y-axis motor 32 according to the X- and Y-coordinate data, the galvano scanning speed data, and the like of the drawing pattern inputted from the laser controller 5. The galvano controller 50 outputs motor drive data representing the computed driving angle and the rotational speed to the galvano driver 57.

The galvano driver 57 drives and controls the galvano X-axis motor 31 and the galvano Y-axis motor 32 according to the motor drive data representing the driving angle and the rotational speed and inputted from the galvano controller 56, thereby performing two-dimensional scan of the laser beam L.

The visible laser driver 58 controls the guide optical section 16 including the visible semiconductor laser 28 according to a control signal outputted from the laser controller 5. The visible laser driver 58 controls, for example, a light amount of the visible laser beam M emitted from the visible semiconductor laser 28 according to the control signal. The pointer beam driver 59 controls the pointer beam emitting unit 39 disposed in the main enclosure 35 of the machining chamber 4 according to a control signal outputted from the laser controller 5 to control the emission of the pointer beam P.

As illustrated in FIGS. 1 and 4, the laser controller 5 is connected to the PC 7, and the bi-directional communications can be made between the two. The laser controller 5 is configured to be able to receive drawing data indicating machining contents, control parameters of the laser machining main unit 2, various user instructions, and the like from the PC 7.

(Control System of PC)

Next, the configuration of the control system of the PC 7 will be described with reference to the drawings. As illustrated in FIG. 4, the PC 7 is configured of a control unit 70 for governing overall operations of the PC 7, an input operation unit 76, a liquid crystal display (LCD) 77, a CD-R/W 78, and the like. The input operation unit 70 includes a mouse, a keyboard, and the like. The CD-R/W 78 is provided for reading from and writing into CD-ROMs 79 various types of data, programs, and the like.

The control unit 70 includes a CPU 71, a RAM 72, a ROM 73, a timer 74, a hard disk drive (HDD) 75, and the like. The CPU 71 is provided as an arithmetic device and a control device for governing overall operations of the PC 7. The timer 74 is provided for measuring time. The CPU 71, the RAM 72, the FOM 72, and the timer 74 are interconnected via a bus line (not shown), and are in data communication with one another. The CPU 71 and the HDD 75 are interconnected via an input-output interface (not shown), and are in data communication with each other.

The RAM 72 temporarily stores various results of arithmetic operation performed by the CPU 71 and the like. The ROM 73 stores various kinds of control programs and data tables.

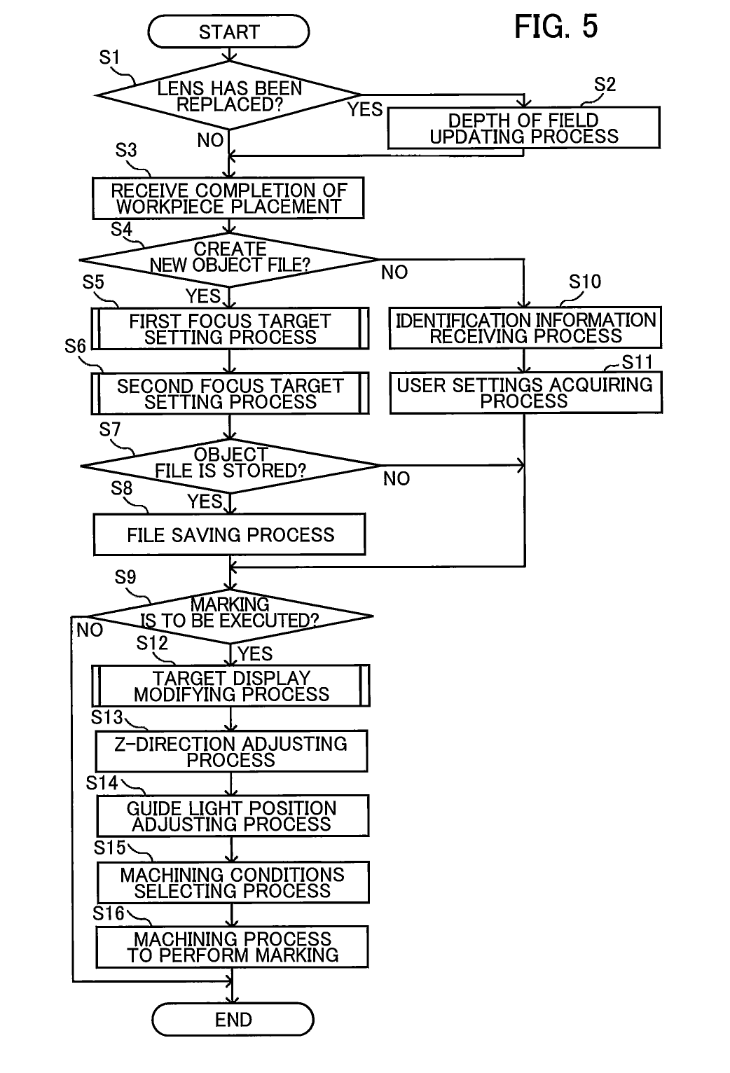

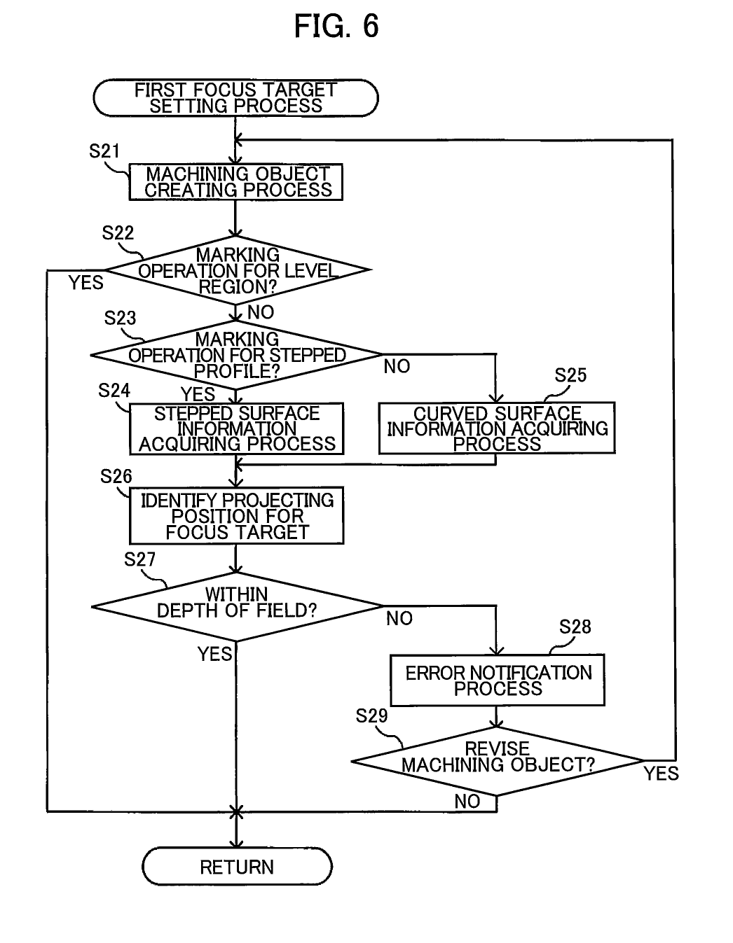

The HDD 75 is a storage device that stores various programs for application software and various data files. In the present embodiment, the HDD 75 stores a program for a main process (see FIG. 5), and various subroutines for the main process program (see FIGS. 6, 11, 12, 15, and the like). The HDD 75 also stores a plurality of object files. Each object file includes a description of a machining object that specifies content to be drawn on the surface of the workpiece W during marking, and information specifying the projecting position of a focus target T described later and a projecting form (the shape of the focus target T and the inclusion of an optical focus guide G, for example).

Note that the focus target T is configured with a framing outline O projected onto the surface of the workpiece W with the visible laser beam M and is used when adjusting the position of the workpiece W in the Z-direction (see FIG. 10 and the like). That is, the workpiece W can be adjusted to a desired position in the Z-direction by aligning the irradiated position of the pointer beam P with the center portion in the framing outline O of the focus target T.

The CD-R/W 78 reads an application program and various data tables or other datasets from the CD-ROM 79, or writes such data to the CD-ROM 79. For example, the PC 7 reads the main process program (see FIG. 5) and its various subroutines (see FIGS. 6, 11, 12, 15, and the like) from the CD-ROM 79 via the CD-R/W 78 and stores this program and subroutines on the HDD 75.

Note that the main process program and its subroutines may instead be stored in the ROM 73 or may be read from a storage medium, such as the CD-ROM 79. Alternatively, the program and subroutines may be downloaded over a network, such as the Internet (not shown).

The input operation unit 76, which is configured of a mouse, a keyboard, and the like; the LCD 77; and the like are electrically connected to the PC 7 via an input/output interface (not shown). Hence, the input operation unit 76 and the LCD 77 of the PC 7 are used for specifying various settings needed for drawing on the surface of the workpiece W with the laser beam L.

(Description of the Main Process)

Next, the main process implemented by the main process program executed on the PC 7 will be described in detail with reference to FIGS. 5 through 17. The main process program is an application program executed by the CPU 71 for adjusting the position of the workpiece W and the focal point of the laser beam L for marking the surface of the workpiece W.

In S1 at the beginning of the main process illustrated in FIG. 5, the CPU 71 determines whether the fθ lens 20 constituting the optical member in the laser machining unit 1 has been replaced. In the present embodiment, the CPU 71 determines that the fθ lens 20 has not been replaced if an operation specifying that the fθ lens 20 has been replaced is not executed on the input operation unit 76 within a prescribed interval. The CPU 71 advances to S3 when the fθ lens 20 has not been replaced (S1: NO) and advances to S2 when the fθ lens 20 has been replaced (S1: YES).

While the process in S1 for determining whether the fθ lens 20 has been replaced relies on a user operation performed on the input operation unit 76 in the present embodiment, the present disclosure is not limited to this configuration. For example, each fθ lens 20 may be provided with a wireless tag that stores unique lens identification information. Thus, the CPU 71 can perform the determination in S1 by reading and comparing the lens identification information stored on the wireless tag of the fθ lens 20.

In S2 the CPU 71 executes a depth of field updating process to coincide with the replacement of the fθ lens 20. In this process, the CPU 71 updates depth of field information used as reference for determining whether marking can be performed on the surface of a workpiece W having different height levels. Since each fθ lens 20 has an intrinsic depth of field DF, as described above, the CPU 71 requests the user to input depth of field information specifying the depth of field DF of the new fθ lens 20. Upon receiving depth of field information inputted via the input operation unit 76, the CPU 71 stores this information in the HDD 75 in relation to the fθ lens 20, ends the depth of field updating process of S2, and advances to S3.

Note that the depth of field information need not be inputted via the input operation unit 76 in the depth of field updating process of S2, but may be inputted according to various other methods. For example, if each fθ lens 20 is provided with a wireless tag, as described above, the depth of field information may be stored on the wireless tag. Thus, the CPU 71 may execute the depth of field updating process in S2 by reading the depth of field information from the wireless tag provided on the new fθ lens 20.

In order to adjust the position of the workpiece W in the Z-direction, in S3 the CPU 71 waits until a workpiece W has been placed on the mounting unit inside the machining chamber 4 and until a user operation has been received via the input operation unit 76 indicating that placement of the workpiece W is complete. The CPU 71 advances to S4 upon receiving a user operation via the input operation unit 76 indicating that a workpiece W has been placed on the mounting unit.

In S4 the CPU 71 determines on the basis of operation signals from the input operation unit 76 whether to create a new object file specifying user-desired settings that include the machining content for a marking process, and the projecting position, projecting form, and the like of the focus target T. If the user wishes to create a new object file (S4: YES), the CPU 71 advances to S5 to perform a first focus target setting process. However, if the user does not wish to create a new object file (S4: NO), the CPU 71 determines that the object file stored on the HDD 75 will be used, and advances to S10. Here, the CPU 71 may be configured to advance to the process in S5 if after advancing to S10 the CPU 71 references the HDD 75 and determines that an object file is not stored therein.

In S5 the CPU 71 executes the first focus target setting process for performing processes related to creating an object file including content of the machining object and the projecting position of the focus target T. In the first focus target setting process of S5, the CPU 71 reads a program for the first focus target setting process (see FIG. 6) from the HDD 75 and executes the program.

(Description of the First Focus Target Setting Process)

In S21 at the beginning of the first focus target setting process illustrated in FIG. 6, the CPU 71 executes a machining object creating process to create drawing content indicating what is to be drawn on the surface of the workpiece W during marking. After the machining object has been created and stored in the RAM 72, the CPU 71 ends the machining object creating process and advances to S22.

In S22 the CPU 71 determines whether marking is to be performed in a level region of the workpiece W (i.e., a region having a flat profile). More specifically, the CPU 71 displays a message on the LCD 77 asking the user whether marking is to be performed in a level region and waits until an operation is received via the input operation unit 76 in response. When marking is to be performed in a level region (S22: YES), the CPU 71 ends the first focus target setting process without taking any action, and advances to S6 in the main process. However, if marking is not to be performed in a level region (S22: NO), i.e., if marking is to be performed in a non-level region (a region having different height levels), the CPU 71 displays a surface condition input window 80 on the LCD 77, prompting the user to input surface information for performing marking in a non-level region, and subsequently advances to S23.

(Structure of the Machining Condition Input Window)

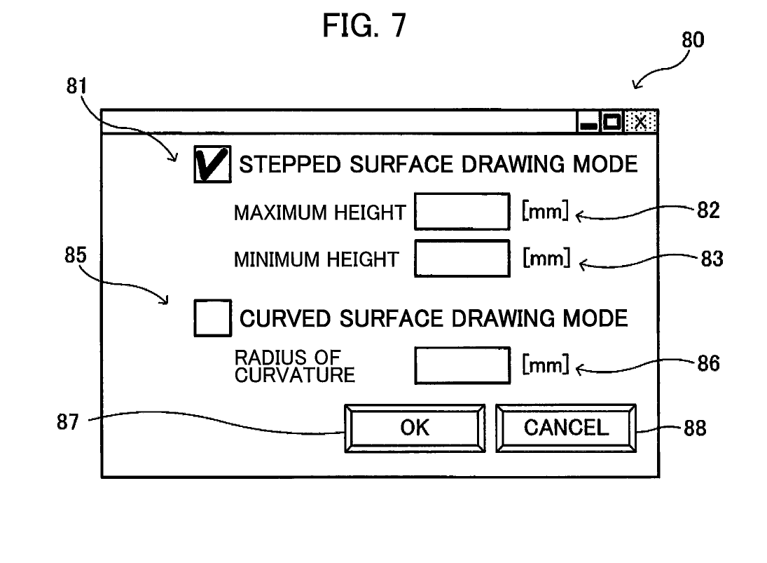

By performing various input operations in the surface condition input window 80 using the input operation unit 76, the user can input settings for a marking process in a non-level region having height differences in the profile. As illustrated in FIG. 7, the surface condition input window 80 has a stepped surface drawing setting section 81, and a curved surface drawing setting section 85. Under the stepped surface drawing setting section 81, the surface condition input window 80 has a maximum height field 82, and a minimum height field 83. Under the curved surface drawing setting section 85, the surface condition input window 80 has a radius of curvature field 86. The surface condition input window 80 also includes an OK button 87 and a CANCEL button 88.

The stepped surface drawing setting section 81 is configured of the character string “STEPPED SURFACE DRAWING MODE” and a checkbox. Using the input operation unit 76 to perform an operation in the checkbox, the user can check and uncheck the box. Thus, through an operation in the stepped surface drawing setting section 81, the user can toggle on and off the stepped surface drawing mode for marking a surface of the workpiece W having a stepped profile.

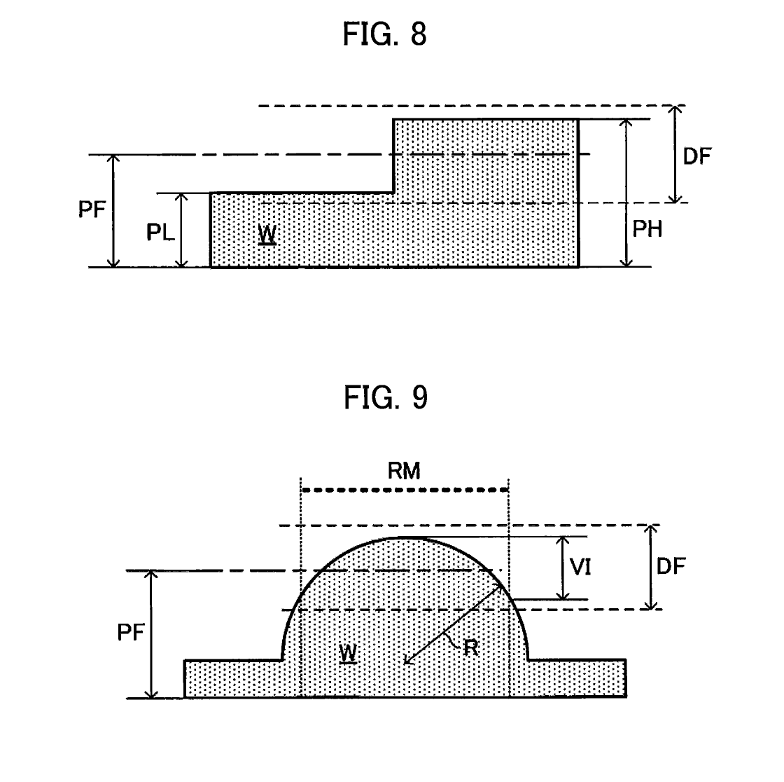

The maximum height field 82 accepts the input of information specifying a highest profile position PH (see FIG. 8) in the Z-direction within the surface of the workpiece W for the stepped surface drawing mode. The highest profile position PH corresponds to the first position in the present disclosure. In the present embodiment, the user performs an operation using the input operation unit 76 to input a numerical value related to the Z-direction to specify the highest profile position PH.

The minimum height field 83 accepts the input of information specifying a lowest profile position PL (see FIG. 8) in the Z-direction within the surface of the workpiece W for the stepped surface drawing mode. The lowest profile position PL corresponds to the second position in the present disclosure. In the present embodiment, the user performs an operation using the input operation unit 76 to input a numerical value related to the Z-direction to specify the lowest profile position PL.

The curved surface drawing setting section 85 is configured of the character string “CURVED SURFACE DRAWING MODE” and a checkbox. Using the input operation unit 76 to perform an operation in the checkbox, the user can check and uncheck the box. Thus, through an operation in the curved surface drawing setting section 85, the user can toggle on and off the curved surface drawing mode for marking a surface of the workpiece W having a curved profile.

The radius of curvature field 86 accepts the input of information specifying the degree of curvature in the curved surface of the workpiece W in the form of a radius of curvature. In the present embodiment, the user performs an operation using the input operation unit 76 to input a numerical value for a radius of curvature R (see FIG. 9) specifying the degree of curvature in the curved surface of the workpiece W.

The user operates the OK button 87 once input is complete for all fields in the surface condition input window 80. When the user performs an input operation on the OK button 87, the CPU 71 sets the projecting position of the focus target T and the like on the basis of the conditions acquired through the fields in the surface condition input window 80. The CANCEL button 88 is operated when the user wishes to cancel the conditions inputted in the fields of the surface condition input window 80 and to re-enter settings in those fields.

In S23 the CPU 71 determines whether the marking operation is for a stepped profile on the basis of the operation signals received from the input operation unit 76 for the surface condition input window 80. If the CPU 71 determines that the marking operation is for a stepped profile, on the basis of a check operation performed in the stepped surface drawing setting section 81 (S23: YES), the CPU 71 advances to S24. However, if the CPU 71 determines that the marking operation is not for a stepped profile (S23: NO), the CPU 71 advances to S25 to form a marking operation on a curved surface.

In S24 the CPU 71 executes a stepped surface information acquiring process to acquire user operations in the maximum height field 82 and the minimum height field 83 of the surface condition input window 80. Once the user has selected the OK button 87 after inputting information related to the highest profile position PH and the lowest profile position PL in the corresponding maximum height field 82 and minimum height field 83, the CPU 71 stores information for the maximum height position and the minimum height position in the RAM 72 and advances to S26.

If the CPU 71 advances to S25 rather than S24, the CPU 71 executes a curved surface information acquiring process to acquire a user operation in the radius of curvature field 86 of the surface condition input window 80. Once the user selects the OK button 87 after having inputted information in the radius of curvature field 86 related to the radius of curvature R, the CPU 71 stores the radius of curvature information in the RAM 72 and advances to S26.

In S26 the CPU 71 uses the information acquired in the stepped surface information acquiring process of S24 or the curved surface information acquiring process of S25 to identify the position of the workpiece W relative to the focal point of the laser beam L. The position of the workpiece W relative to the focal point of the laser beam L will hereinafter be called the “focal position PF.” The CPU 71 then identifies a projecting position for the focus target T corresponding to the focal position PF. The projecting position for the focus target T corresponding to the focal position PF will hereinafter be called a “defocused position PD.”

Here, the method of identifying the focal position PF will be described. When marking a stepped profile, the CPU 71 identifies the focal position PF to be a position between the highest profile position PH and the lowest profile position PL of the stepped profile (such as a center position between the highest profile position PH and the lowest profile position PL; see FIG. 8). If the marking process is for a curved surface, the CPU 71 calculates a vertical interval VI within the machining region RM on the basis of the size of the machining region RM in which the machining object is to be marked, and the numerical value for the radius of curvature R, and identifies the focal position PF to be the center position in the vertical interval VI (see FIG. 9).

Next, the method of calculating the projecting position of the focus target T on the basis of this focal position PF will be described. Specifically, the CPU 71 calculates a displacement amount of the projecting position for the focus target T corresponding to the focal position PF from the projecting position of the focus target T at the focused position of the laser beam L on the basis of a defocusing amount at the focal position PF and the inclination angle θ of the pointer beam P (see FIG. 10). The projecting position of the focus target T at the focused position of the laser beam L will hereinafter be called the “initial projecting position,” and the defocusing amount at the focal position PF denotes the difference between the focused position of the laser beam L and the focal position PF in the Z-direction. Here, the focused position of the laser beam L is the position at which the defocusing amount is 0. Next, the CPU 71 identifies the projecting position for the focus target T corresponding to the focal position PF (i.e., the defocused position PD) on the basis of the initial projecting position of the focus target T and the displacement amount calculated above. After storing information related to the defocused position PD in the RAM 72, the CPU 71 advances to S27.

In FIG. 10, the focus target T for the initial projecting position is depicted with a dotted line as a virtual focus target TI.

In S27 the CPU 71 determines on the basis of the depth of field information stored in the HDD 75 whether the surface of the workpiece W inside the machining region RM falls within the depth of field DF of the fθ lens 20 in the Z-direction when the focal position PF identified in S26 is adjusted so as to be aligned with the focused position of the laser beam L by moving the mount unit along with the workpiece W in the Z-direction. That is, the CPU 71 determines in S27 whether marking of the machining object can be performed without trouble when the focused position of the laser beam L is adjusted to the current focal position PF in the Z-direction. When the surface of the workpiece W inside the machining region RM falls within the depth of field DF of the fθ lens 20 (S27: YES), as illustrated in FIGS. 8 and 9, the CPU 71 ends the first focus target setting process and advances to S6 in the main process. However, if the surface of the workpiece W inside the machining region RM does not fall within the depth of field DF of the fθ lens 20 (S27: NO), i.e., when the surface of the workpiece W at any point inside the machining region RM falls outside the depth of field DF of the fθ lens 20, the CPU 71 advances to S28.

Since there is a high probability that problems will occur during marking if any part of the surface of the workpiece W inside the machining region RM falls outside the depth of field DF of the fθ lens 20, in S28 the CPU 71 executes an error notification process. In the error notification process of S28, the CPU 71 displays messages on the LCD 77 specifying that the current content has a high probability of producing errors in the marking process and that the content of the machining object must be revised. Subsequently, the CPU 71 advances to S29.

Note that the user may perform any of various operations to end the error notification in the process of S28. For example, the notification in the process of S28 may be ended when the user performs an operation confirming the error notification. Alternatively, the notification in the error notification process of S28 may be ended when the user performs one of the operations in S29 described below, such as an operation indicating a desire to revise the content of the machining object or an operation indicating a desire not to revise the content of the machining object.

In S29 the CPU 71 determines on the basis of operation signals from the input operation unit 76 whether to revise the content of the machining object in response to the error notification in S28. If an operation indicating a desire to revise the content of the machining object is performed (S29: YES), the CPU 71 returns to S21 and performs a process for modifying the machining object. However, if an operation indicating a desire to revise the content of the machining object is not performed (S29: NO), the CPU 71 stores information in the RAM 72 indicating that the machining object will not be revised, and subsequently ends the first focus target setting process. Thereafter, the CPU 71 advances to S6 in the main process.

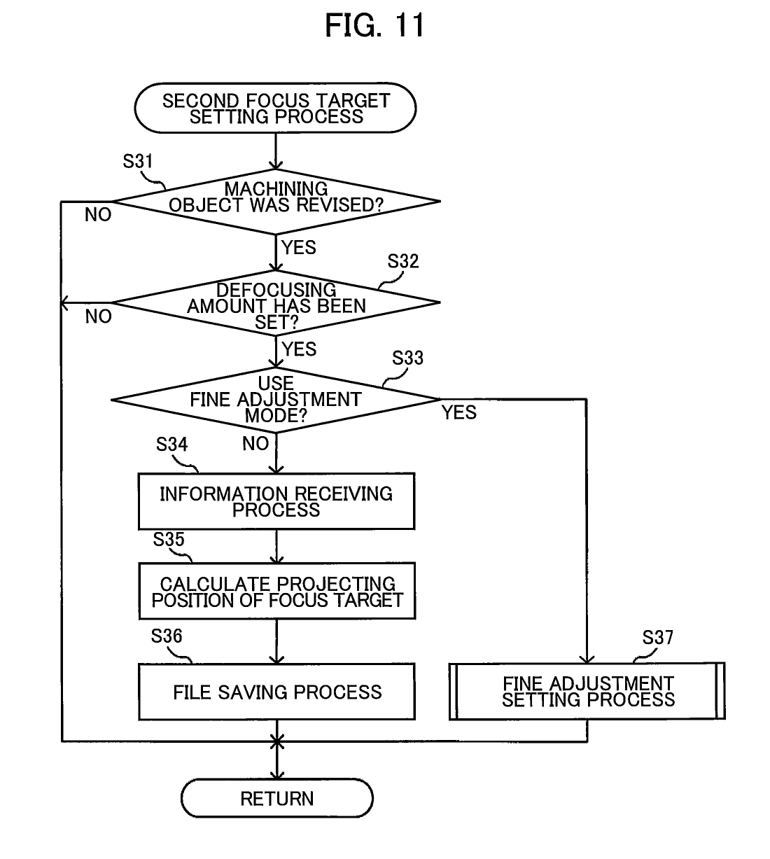

In S6 of the main process (see FIG. 5), the CPU 71 executes a second focus target setting process to perform processing related to the projecting position of the focus target T and the shape and the like of the focus target T. For the process of S6, the CPU 71 reads a program for the second focus target setting process (see FIG. 11) from the HDD 75 and executes the program.

(Description of the Second Focus Target Setting Process)

When advancing to the second focus target setting process of S6 illustrated in FIG. 11, in S31 the CPU 71 references the content stored in the RAM 72 to determine whether the machining object was revised in the first focus target setting process of S5. If the machining object was not revised in S5 (S31: NO), the CPU 71 ends the second focus target setting process and advances to S7 in the main process. However, if the machining object was revised (S31: YES), the PC 7 advances to S32.

In S32 the CPU 71 determines whether the defocusing amount has been set on the basis of the content of the current object file. If a defocusing amount has been set (S32: YES), the CPU 71 advances to S33. Here, the CPU 71 may determine that a defocusing amount was set on the basis of the focal position PF when marking is to be performed on a stepped profile, as illustrated in FIG. 8, or marking is to be performed on a curved surface, as illustrated in FIG. 9. However, if a defocusing amount has not been set (S32: NO), the CPU 71 ends the second focus target setting process and subsequently advances to S7 in the main process.

In S33 the CPU 71 determines on the basis of operation signals received from the input operation unit 76 whether to use a fine adjustment mode that enables fine adjustments in reference to the focal position PF and on the basis of the prescribed defocusing amount when adjusting the position of the workpiece W in the Z-direction. The CPU 71 advances to S37 when the fine adjustment mode is to be used (S33: YES) and advances to S34 when the fine adjustment mode is not to be used (S33: NO).

In S34 the CPU 71 executes a process to receive workpiece information and the like, and subsequently waits for the user to input information required for identifying the projecting position of the focus target T. More specifically, the CPU 71 displays a message on the LCD 77 prompting the user to input various information including information required for identifying the projecting position of the focus target T and subsequently receives input operations for such information via the input operation unit 76. In this example, information required for identifying the projecting position of the focus target T denotes information specifying the defocusing amount. Other information may include information related to the workpiece, such as information on an allowable width of the workpiece W and information specifying the material composition of the workpiece W. After completing the information receiving process of S34, the CPU 71 advances to S35.

In S35 the CPU 71 calculates the projecting position of the focus target T on the basis of information specifying a defocusing amount received in S34. At this time, if information specifying the allowable width of the workpiece W and the material composition of the workpiece W was inputted in the process of S34, the CPU 71 sets the projecting size of the focus target T on the basis of the allowable width and the material composition of the workpiece W and stores this size in the RAM 72 together with information for the projecting position of the focus target T. After storing the projecting position and other information in the RAM 72, the CPU 71 advances to S36.

The process of S35 is performed on the basis of the assumption that workpieces W with different compositions (constituent materials, for example) may have greatly different finished states after performing a marking process with the laser beam L of the laser machining apparatus 100, even when all other process conditions are unchanged. For example, when the workpiece W is composed of a material such as a plastic whose finished state readily varies depending on the amount of heat absorbed, the marking process performed by the laser beam L may produce different results in response to variations in the amount of heat absorbed by the workpiece W. Therefore, when the material composition of the workpiece W has a tendency to produce a finished state that varies according to heat absorption, in S35 the CPU 71 sets the projecting size of the focus target T smaller than when the composition of the workpiece W is not prone to such variation. By executing the process in S35, the CPU 71 can project the focus target T at a size suitable for the composition of the workpiece W. Accordingly, the position of the mounting unit in the Z-direction can be adjusted more precisely while accounting for the composition of the workpiece W.

In S36 the CPU 71 executes a file saving process to create an object file that includes information specifying the projecting position of the focus target T stored in the RAM 72 and to store this object file in the HDD 75 in association with identification information identifying the object file (the filename of the object file, for example). Subsequently, the CPU 71 ends the second focus target setting process and advances to S7 in the main process.

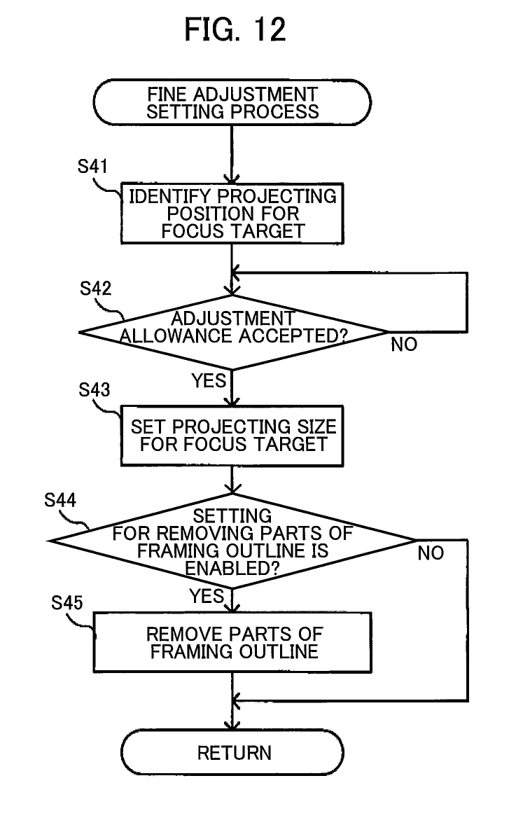

In S37 the CPU 71 executes a fine adjustment setting process for setting the projecting size and the like for the focus target T in order to finely adjust the position of the workpiece W in the Z-direction in reference to the focal position PF and on the basis of the defocusing amount. In the fine adjustment setting process of S37 the CPU 71 reads a program for the fine adjustment setting process (see FIG. 12) from the HDD 75 and executes this program.

(Description of the Fine Adjustment Setting Process)

When advancing to the fine adjustment setting process of S37 illustrated in FIG. 12, in S41 the CPU 71 calculates a displacement amount of the projecting position for the focus target T corresponding to the focal position PF from the initial projecting position of the focus target T on the basis of the defocusing amount set in the current object file and the inclination angle θ of the pointer beam P, and identifies the projecting position for the focus target T corresponding to the focal position PF (i.e., the defocused position PD) on the basis of the initial projecting position of the focus target T and the displacement amount calculated above. After storing information for the defocused position PD in the RAM 72, the CPU 71 advances to S42.

In S42 the CPU 71 accepts input for information specifying an adjustment allowance and determines whether such input has been received on the basis of operation signals from the input operation unit 76. The adjustment allowance in this case denotes a displacement amount for performing fine adjustments to the position of the workpiece W in the Z-direction in reference to the focal position PF and on the basis of the defocusing amount. When information specifying an adjustment allowance is inputted (S42: YES), the CPU 71 advances to S43. However, if such input is not received (S42: NO), the CPU 71 waits until information specifying an adjustment allowance is inputted.

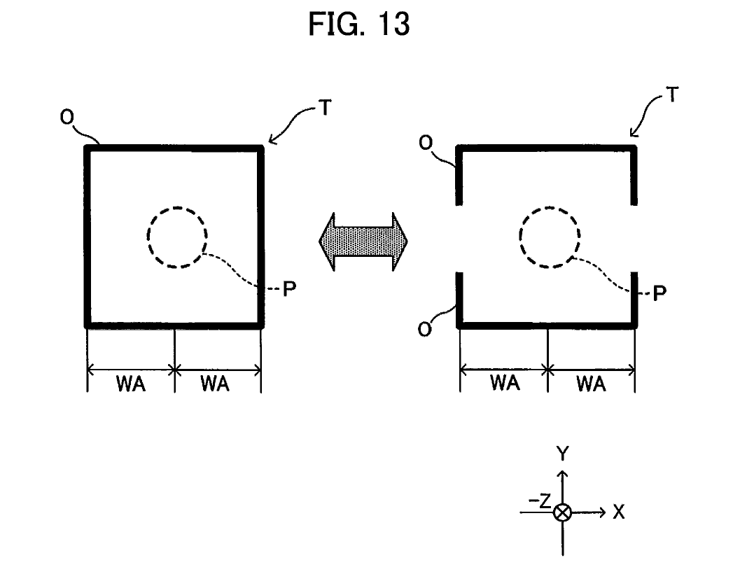

In S43 the CPU 71 calculates an adjustment width WA corresponding to the adjustment allowance on the basis of the adjustment allowance received in S42 and the inclination angle θ of the pointer beam P, and sets the projecting size for the focus target T on the basis of the adjustment width WA. The adjustment width WA specifies the dimension between the center portion of the focus target T and the projecting position of the framing outline θ in the X-direction (see FIG. 13). After setting the projecting size for the focus target T, the CPU 71 advances to S44.

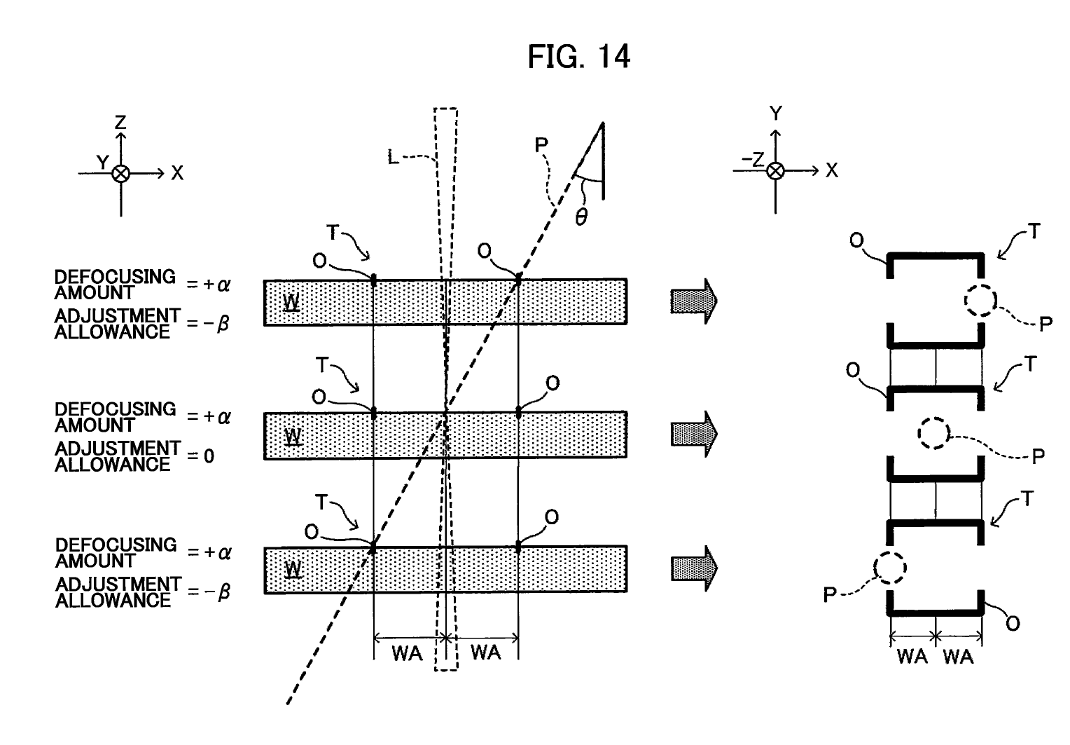

As illustrated in FIG. 14, when the projecting size for the focus target T is set on the basis of the adjustment allowance, the irradiating position of the pointer beam P is adjusted over the framing outline O of the focus target T. This operation adjusts the position of the workpiece W in the Z-direction by a width corresponding to the adjustment allowance with reference to the defocusing amount.

In S44 the CPU 71 determines whether a setting for removing part of the framing outline O in the focus target T (hereinafter called a removal setting) is enabled on the basis of operation signals from the input operation unit 76. As illustrated in FIG. 13, the removal setting removes parts of the framing outline O in the focus target T that overlap the pointer beam P moving in the X-direction while the position of the workpiece W is adjusted in the Z-direction. When the removal setting is enabled (S44: YES), the CPU 71 advances to S45. However, if the removal setting is not enabled (S44: NO), the CPU 71 ends the fine adjustment setting process with no change, ends the second focus target setting process (see FIG. 11), and advances to S7 in the main process (see FIG. 5).

In S45 the CPU 71 removes the parts of the framing outline O in the focus target T that overlap the pointer beam P moving in the X-direction while the position of the workpiece W is adjusted in the Z-direction. As a result, the visible laser beam M projecting the focus target T can be easily distinguished from the pointer beam P when the framing outline O of the focus target T is aligned with the irradiating position of the pointer beam P, as illustrated in FIG. 14, enabling precise fine adjustments in the workpiece W on the basis of the adjustment allowance. After removing portions of the framing outline O, the CPU 71 ends the fine adjustment setting process and the second focus target setting process (see FIG. 11), and advances to S7 in the main process (see FIG. 5).

After advancing to S7 in the main process illustrated in FIG. 5, the CPU 71 determines on the basis of operation signals from the input operation unit 76 whether to store an object file created through the first focus target setting process of S5 and the second focus target setting process of S6 in the HDD 75 as user settings. The CPU 71 advances to S8 when the current object file is stored as user settings (S7: YES) and advances to S9 when the current object file is not stored as user settings (S7: NO).

In S8 the CPU 71 executes the file saving process to store the object file created in the first focus target setting process of S5 and the second focus target setting process of S6 in the HDD 75 as user settings together with identification information specifying the object file (the filename of the object file, for example). After storing the object file in the HDD 75, the CPU 71 advances to S9.

In S9 the CPU 71 determines on the basis of operation signals received from the input operation unit 76 whether a marking process is to be performed according to the current object file. If marking is to be performed according to the current object file (S9: YES), the CPU 71 advances to S12. However, if marking is not to be performed according to the current object file (S9: NO), the CPU 71 ends the main process with no further change. In the latter case, the laser machining apparatus 100 does not actually perform marking, but can preserve the object file stored in the HDD 75 in the file saving process of S8 as user settings for later use.

On the other hand, if the CPU 71 determines in S4 that a new object file was not created (S4: NO) and advances to S10, the CPU 71 executes an identification information receiving process to receive the input of identification information for identifying a single object file to be used in the current marking process in order to use an object file stored on the HDD 75 that specifies user-desired settings. More specifically, the CPU 71 displays a list of identification information on the LCD 77 for all object files stored on the HDD 75 and receives identification information inputted for a selected object file on the basis of operation signals for a user operation to select identification information via the input operation unit 76. After receiving the inputted identification information, the CPU 71 advances to S11.

In S11 the CPU 71 executes a user settings acquiring process to identify the object file to be used in the current marking process on the basis of the identification information acquired in S10 and to acquire this object file from the HDD 75. After acquiring this object file as user settings, the CPU 71 advances to S9.

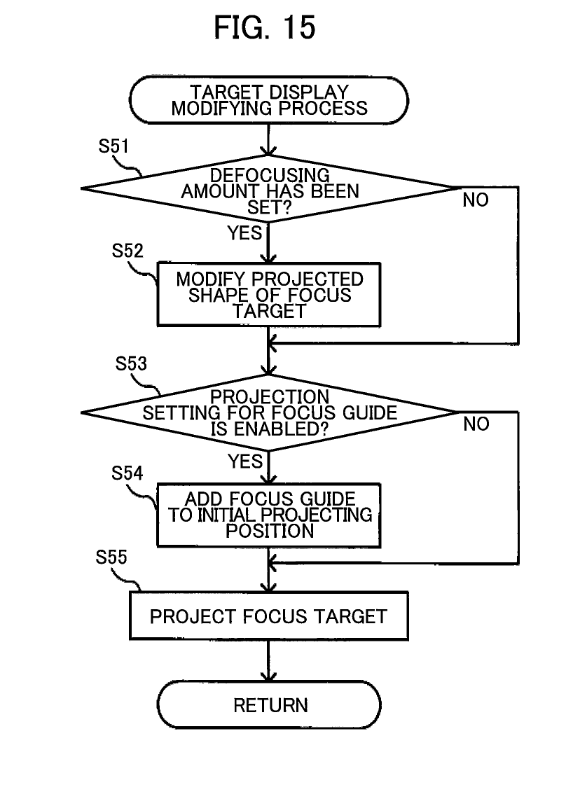

When the CPU 71 determines in S9 that a marking process is to be performed (S9: YES), in S12 the CPU 71 executes a target display modifying process in order to perform settings related to the shape of the focus target T and the presence of the optical focus guide G. To perform this process, the CPU 71 reads a program for the target display modifying process (see FIG. 15) from the HDD 75 and executes the program.

(Description of the Target Display Modifying Process)

When advancing to the target display modifying process of S12 illustrated in FIG. 15, in S51 the CPU 71 references the current object file to determine whether a defocusing amount has already been set. In other words, the defocusing amount may have already been set by the time the CPU 71 executes the determination in S51. Here, the timing for setting the defocusing amount may be any timing that precedes the determination process in S51. If the defocusing amount has already been set (S51: YES), the CPU 71 advances to S52. However, if the defocusing amount has not yet been set (S51: NO), i.e., when the defocusing amount is 0, the CPU 71 advances to S53.

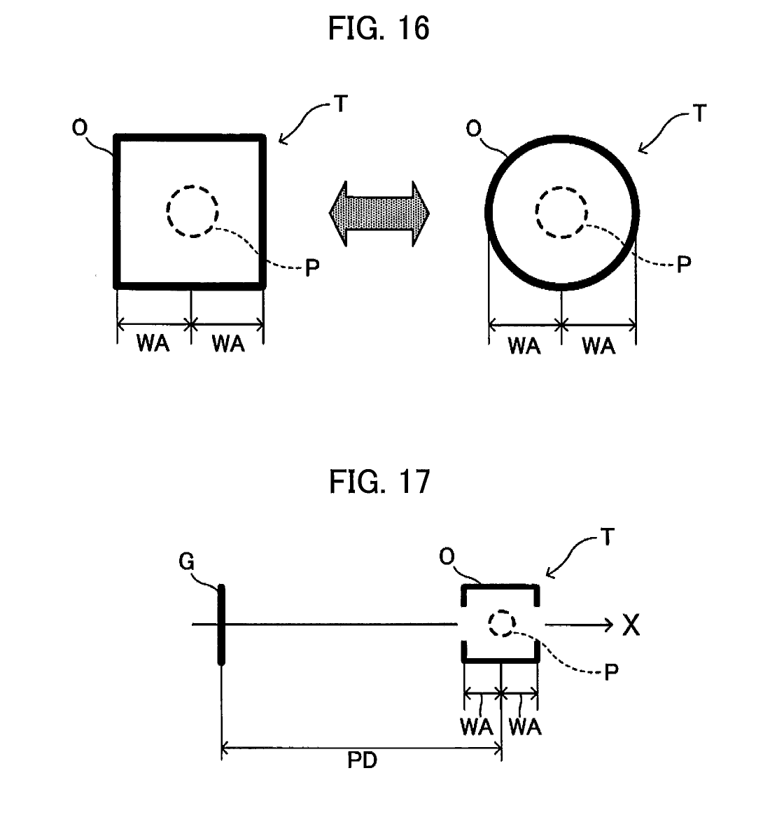

In S52 the CPU 71 modifies the projected shape of the focus target T in response to the determination of S51 that defocusing amount has already been set. More specifically, the CPU 71 modifies the shape of the framing outline O constituting the focus target T. That is, the CPU 71 modifies the shape of the framing outline O from a circular shape to a square shape, as illustrated in FIG. 16. Thus, in the present embodiment, the focus target T is projected with a circular framing outline O when the defocusing amount has not been set, and is changed to a focus target T with a square-shaped framing outline O when a defocusing amount has been set. After modifying the shape of the focus target T, the CPU 71 advances to S53.

In S53 the CPU 71 determines on the basis of operation signals received from the input operation unit 76 whether a setting for projecting the optical focus guide G with the visible laser beam M has been enabled. The optical focus guide G denotes the initial projecting position of the focus target T and indicates the projecting position of the focus target T when setting the position of the workpiece W in the Z-direction to the focused position of the laser beam L (where the focused position is the position at which the defocusing amount is 0). If the projection setting for the optical focus guide G is enabled (S53: YES), the CPU 71 advances to S54. If the projection setting for the optical focus guide G is not enabled (S53: NO), the CPU 71 advances to S55.

In S54 the CPU 71 adds the optical focus guide G to the initial projecting position on the surface of the workpiece W. By displaying the optical focus guide G at the initial projecting position on the surface of the workpiece W through this action, as illustrated in FIG. 17, the user can discern the defocusing amount at the current point in time by visually confirming the relative positions of the optical focus guide G and the defocused position PD, which is the projecting position of the focus target T on the basis of the defocusing amount. This can improve convenience for the user when performing position adjusting operations for the workpiece W in the Z-direction. After adding the optical focus guide G, the CPU 71 advances to S55.

In S55 the CPU 71 projects the focus target T at the projecting position of the focus target T corresponding to the focal position PF calculated in S26 and the like by controlling the guide optical section 16 and the galvano scanner 19 on the basis of information for the focus target T defined in the current object file (see FIGS. 6, 14, and the like). At this time, the CPU 71 projects the focus target T and the optical focus guide G with the visible laser beam M according to the projecting size of the focus target T set in S35 on the basis of the composition of the workpiece W, the projecting size of the focus target T set in S43 on the basis of the adjustment allowance, the removal setting for the framing outline O of the focus target T set in S45, the projected shape of the framing outline O set in S52, and the presence of the optical focus guide G set in S54 (see FIGS. 13, 16, and 17). After projecting the focus target T on the surface of the workpiece W according to the format specified in settings in the object file, the CPU 71 ends the target display modifying process and advances to S13 in the main process (see FIG. 5).

In S13 the CPU 71 executes a Z-direction adjusting process to adjust the positional relationship of the workpiece W disposed on the mounting unit and the focal point of the laser beam L in the Z-direction, which is orthogonal to the surface of the mounting unit in the main enclosure 35. More specifically, while the focus target T is projected at the projecting position on the surface of the workpiece W disposed on the mounting unit corresponding to the focal position PF through the process of S55 in the target display modifying process of FIG. 15, the user adjusts the position of the workpiece W on the mounting unit relative to the X-direction and the Y-direction while referencing the focus target T.

Subsequently, the CPU 71 controls the pointer beam emitting unit 39 via the pointer beam driver 59 to irradiate the pointer beam P. When the pointer beam P is irradiated onto the surface of the workpiece W disposed on the mounting unit, the user moves the mounting unit vertically within the main enclosure 35 so that the light spot formed by the pointer beam P on the surface of the workpiece W is aligned with the center region of the framing outline O in the focus target T projected by the visible laser beam M on the surface of the workpiece W (see FIG. 10). After adjusting the relative positions of the focus target T and the spot formed by the pointer beam P on the surface of the workpiece W, the user performs an operation (i.e., a Z-direction adjustment operation) on the input operation unit 76 to indicate that the positional adjustments for the workpiece W relative to the Z-direction are complete. Upon receiving this Z-direction adjustment operation indicating completion of the Z-direction adjustments on the basis of operation signals from the input operation unit 76, the CPU 71 ends the Z-direction adjusting process of S13 and advances to S14.

Note that to perform fine adjustments based on the adjustment allowance, the user moves the mounting unit vertically within the main enclosure 35 in order to align the spot formed on the surface of the workpiece W by the pointer beam P with the framing outline O in the focus target T projected on the surface of the workpiece W by the visible laser beam M (see FIG. 14). In this case, the CPU 71 still advances to S14 after the user has adjusted the relative positions of the focus target T projected on the surface of the workpiece W and the spot of the pointer beam P formed on the surface of the workpiece W.

By adjusting the relative positions of the focus target T and the spot formed by the pointer beam P, the relative positions of the surface of the workpiece W and the focal point of the laser beam L in the Z-direction can be adjusted to a desired relationship with the focal position PF and the like corresponding to the defocusing amount. As a result, the focal plane configured by the focal point of the laser beam L is adjusted to a desired position that is separated a prescribed distance from the surface of the mounting unit in the Z-direction. Accordingly, the surface of the workpiece W within the machining region RM is positioned at a desired position corresponding to the focal plane at any position on the mounting unit.

In S14 the CPU 71 executes a process for adjusting the position of the guide light. This process is performed to adjust the position of the workpiece W placed on the mounting unit to a desired position in the X-direction and the Y-direction on the basis of the projected position of the focus target T arbitrarily set on the surface of the workpiece W disposed on the mounting unit. Specifically, the CPU 71 first projects the focus target T with the visible laser beam M at the projecting position set to an arbitrary position on the surface of the workpiece W. After the focus target T is projected at the arbitrary projecting position on the surface of the workpiece W, the user adjusts the position of the workpiece W to the user's preferred position relative to the X-direction and the Y-direction of the mounting unit while using the focus target T as reference. In this way, the workpiece W is placed at an arbitrary position on the mounting unit relative to the X-direction and the Y-direction while maintaining its position relative to the Z-direction. Subsequently, the CPU 71 advances to S15.

In S15 the CPU 71 executes a process to select machining conditions. In this process, the user selects such conditions as the output intensity and scanning speed of the laser beam L for the marking process, the number of scans, and the like. After storing the user-specified machining conditions in the RAM 72, the CPU 71 ends the process for selecting machining conditions and advances to S16.

In S16 the CPU 71 executes a machining process to perform marking with the laser beam L on the surface of the workpiece W placed in the arbitrary position on the mounting unit. Specifically, the CPU 71 scans the laser beam L via the laser controller 5 to draw the machining object in the object file on the surface of the workpiece W. After completing the machining process of S16, the CPU 71 ends the main process.

As described above, the laser machining apparatus 100 according to the present embodiment has the laser oscillation unit 12, the galvano scanner 19, the fθ lens 20, the guide optical section 16, the pointer beam emitting unit 39, the laser controller 5, and the PC 7. The laser machining apparatus 100 can perform a marking process on the surface of a workpiece W with the laser beam L emitted from the laser oscillation unit 12 by scanning the galvano scanner 19 while using the fθ lens 20.

With the laser machining apparatus 100 and the control program of the laser machining apparatus 100, the CPU 71 receives information inputted into the surface condition input window 80 in the stepped surface information acquiring process of S24 and the curved surface information acquiring process of S25, identifies a focal position PF on the basis of this received information, and projects the focus target T and the pointer beam P after modifying the positional relationship between the focus target T and the pointer beam P in X- and Y-directions on the basis of information specifying the focal position PF. Accordingly, the laser machining apparatus 100 can perform an operation to adjust the position of the workpiece W on the basis of the projected focus target T and the pointer beam P (see FIGS. 10 and 14) to perform accurate positional adjustments even in a direction orthogonal to the surface of the mounting unit. Further, the laser machining apparatus 100 can achieve greater visibility of the focus target T than a mark such as a graduation line, thereby improving user convenience for a position adjusting operation in the vertical direction.

Further, the laser machining apparatus 100 and the like calculate a height difference between the highest profile position PH and the lowest profile position PL on the basis of information inputted in the maximum height field 82 and the minimum height field 83 when marking a stepped profile, or calculates the vertical interval VI within the machining region RM related to a machining object on the basis of the size of the machining region RM and the radius of curvature R inputted in the radius of curvature field 86 when marking a curved surface. Next, the laser machining apparatus 100 sets the focal position PF to a center position between the highest profile position PH and the lowest profile position PL in the vertical interval VI and identifies a projecting position for the focus target T that corresponds to this focal position PF (S26). In this way, the laser machining apparatus 100 can perform a precise position adjusting operation relative to the vertical direction (i.e., an operation to adjust the focal point of the laser beam L, even when the surface of the workpiece W has a vertical interval VI, as in FIGS. 8 and 9. Further, the laser machining apparatus 100 can set a larger process range for the laser beam L than when the focal point of the laser beam L is aligned with one of the highest profile position PH (the top of the curved surface) and the lowest profile position PL.

When the laser machining apparatus 100 determines in S27 that the machining region RM corresponding to the projecting position of the focus target T does not fall in the depth of field DF of the fθ lens 20 constituting the optical member (i.e., the process range; S27: NO), the laser machining apparatus 100 executes the error notification process of S28 to notify the user that problems could occur in the marking process. Consequently, the user can be made aware of such potential problems in the marking process and can take steps to modify the machining object in (S21). In this way, the laser machining apparatus 100 can ensure provision of a workpiece W that has undergone the desired marking process without needlessly wasting a workpiece W.

Further, the laser machining apparatus 100 and the like can acquire an object file preferred by the user from among a list of displayed object files stored on the HDD 75 on the basis of identification information received in the identification information receiving process of S10. Since the focus target T and the like can be projected on the basis of information for the projecting position and the like of the focus target T included in this object file, the laser machining apparatus 100 can project the focus target T at the desired projecting position with high repeatability and without requiring numerous input operations, provided that the object file was stored in the HDD 75 as user settings in the file saving process of S8. Hence, the laser machining apparatus 100 can improve repeatability in marking processes performed on workpieces W, thereby enhancing convenience for users performing multiple marking operations having the same content.

Further, the laser machining apparatus 100 sets the projecting size of the focus target T to a suitable size for the material composition of the workpiece W based on information received in the process for receiving workpiece information and the like in S34 (constituent materials of the workpiece W and the like, for example), and controls the guide optical section 16 and the galvano scanner 19 to project the focus target T at a size corresponding to the composition of the workpiece W. This method assumes that variations may occur in results of a marking process performed with the laser beam L owing to the different constituent materials of workpieces W. For example, if the workpiece W is formed of a plastic material, the results of marking with the laser beam L may be dependent on the amount of heat absorbed by the workpiece W. Since plastics tend to produce finished states that vary according to changes in the amount of heat absorbed, the projecting size of the focus target T is set smaller than when the workpiece W is composed of a material less prone to such changes. Thus, the laser machining apparatus 100 can accurately adjust the position of the mounting unit in the Z-direction while accounting for the constituent materials of the workpiece W in order to project the focus target T at a size suited to the constituent materials of the workpiece W.

When the laser machining apparatus 100 determines that the beam expander 22 constituting the optical member has been replaced (S1: NO), the laser machining apparatus 100 executes the depth of field updating process in S2 to update the depth of field DF specifying the process range in which the laser machining apparatus 100 can perform marking to the depth of field DF of the new fθ lens 20. In this way, the laser machining apparatus 100 can improve accuracy in the determination of S27, thereby improving the notification accuracy in the error notification process of S28 concerning potential problems.

The laser machining apparatus 100 identifies the projecting position for the framing outline O in the focus target T on the basis of information for the adjustment allowance inputted via the input operation unit 76, and controls the guide optical section 16 and the galvano scanner 19 to project the focus target T so as to be configured to include the framing outline O corresponding to this adjustment allowance (see FIGS. 13 and 14). In this way, the laser machining apparatus 100 can adjust the focal point of the laser beam L in units of the adjustment allowance with reference to the framing outline O of the focus target T, and can finely adjust the focal point with high precision (see FIG. 14). More strictly speaking, the laser machining apparatus 100 can perform fine adjustments at units of one-half or one-third the framing outline O.

When a setting is enabled for removing portions of the framing outline O (S44: YES), the laser machining apparatus 100 controls the guide optical section 16 and galvano scanner 19 to project the framing outline O of the focus target T while eliminating those parts of the framing outline O that can overlap the pointer beam P when adjusting the position of the workpiece W in the Z-direction (see FIG. 13). In this way, the laser machining apparatus 100 can project the framing outline O of the focus target T according to a user-desired format, thereby enhancing visibility of the focus target T and framing outline O.

Further, if the defocusing amount has already been set (S51: YES), the laser machining apparatus 100 controls the guide optical section 16 and the galvano scanner 19 to project the framing outline O of the focus target T with a modified shape (see FIG. 16). In this way, the user can discern that the defocusing amount has been modified by visually confirming the shape of the framing outline O. Accordingly, the laser machining apparatus 100 can improve convenience for the user in position adjusting operations. For example, even if one user leaves the laser machining apparatus 100 after modifying the defocusing amount, another user can visually confirm the shape of the framing outline O to determine that the defocusing amount of the laser machining apparatus 100 was modified. In this way, a different user can initialize the settings made by the first user to reliably set a desired defocusing amount.

If the setting for projecting the optical focus guide G has been enabled through operation signals from the input operation unit 76 (S53: YES), the laser machining apparatus 100 controls the guide optical section 16 and the galvano scanner 19 to project the optical focus guide G at the initial projecting position on the surface of the workpiece W (see FIG. 17). Accordingly, the user can discern the degree of defocus at the current point in time by visually confirming the projected positions of the focus target T and optical focus guide G. Thus, the laser machining apparatus 100 can enhance user convenience for position adjustment operations of the workpiece W in the Z-direction.

In the laser machining apparatus 100 according to the embodiment, the laser oscillator 21 of the laser oscillation unit 12 emits a laser beam L according to a passive system. Since the frequency of the laser beam L cannot be modified in a passive system, the laser oscillator 21 is applied more effectively than an oscillator using an active system to irradiate the laser beam L.

In the embodiment described above, the laser machining apparatus 100 is an example of the laser machining apparatus of the disclosure. The laser oscillation unit 12 is an example of the laser beam emitting device in the disclosure, and the galvano scanner 19 is an example of the scanner in the disclosure. The fθ lens 20 is an example of the optical member and the converging lens in the disclosure. The guide optical section 16 is an example of the visible light irradiating device in the disclosure, and the pointer beam emitting unit 39 is an example of the pointer beam emitting device in the disclosure. The input operation unit 76, the LCD 77, and the surface condition input window 80 are examples of the input device in the disclosure. The control unit 70, the CPU 71, and the LCD 77 are examples of the controller in the disclosure. The HDD 75 is an example of the memory in the disclosure. The focus target T is an example of the focus target in the disclosure, and the framing outline O is an example of the framing outline in the disclosure. The optical focus guide G is an example of the optical focus guide in the disclosure.

While the description has been made in detail with reference to a specific embodiment thereof, it would be apparent to those skilled in the art that many modifications and variations may be made thereto without departing from the spirit of the disclosure, the scope of which is defined by the attached claims. For example, in the embodiment described above, the projecting position of the focus target T projected by the visible laser beam M is modified relative to the pointer beam P, thereby modifying the relative positions of the pointer beam P and the focus target T in order to adjust the position of the workpiece W on the basis of the defocusing amount. However, the disclosure is not limited to this configuration.

For example, if the irradiated position of the pointer beam P can be adjusted through operations of the pointer beam emitting unit 39, the irradiated position of the pointer beam P can be adjusted while fixing the projected position of the focus target T, thereby modifying the relative positions of the pointer beam P and the focus target T in order to adjust the position of the workpiece W on the basis of the defocusing amount. In this case, the process for calculating the projecting position of the focus target T in the present embodiment (S26, S35, and S41, for example) may be replaced with a process for calculating the irradiating position of the pointer beam P.

In the embodiment described above, the framing outline O of the focus target T has two shapes: a square shape and a circular shape illustrated in FIG. 16. However, the disclosure is not limited to these shapes. Various other shapes of the framing outline O may be employed, including an elliptical shape, a rectangular shape, and a diamond shape.

What is claimed is:

1. A laser machining apparatus comprising:
a laser beam emitting device configured to emit a laser beam for machining a workpiece disposed on a mounting surface perpendicular to a first direction;
a scanner configured to scan the laser beam emitted from the laser beam emitting device;
an optical member configured to converge the laser beam scanned by the scanner and maintain a focal point of the converged laser beam in a focal plane perpendicular to the first direction, the focal plane being located at a focal position in the first direction;
a visible light irradiating device configured to irradiate a visible light in the first direction, thereby projecting a focus target on the workpiece;
a pointer beam emitting device configured to emit a pointer beam toward the mounting surface at a prescribed inclination angle relative to the first direction, the pointer beam and the focus target being used for adjusting the focal position of the laser beam relative to the workpiece;
an input device configured to receive position information related to a projecting position of one of the focus target and the pointer beam in the first direction; and
a controller configured to perform:
modifying a positional relationship between the focus target and the pointer beam in a second direction perpendicular to the first direction according to the position information; and
projecting the focus target and the pointer beam onto the workpiece.

2. The laser machining apparatus according to claim 1, wherein the workpiece has a machining region,
wherein the position information specifies a first position and a second position, the first position indicating an uppermost position of the machining region in the first direction, the second position indicating a lowermost position of the machining region in the first direction,
wherein the controller is configured to further perform:
calculating a difference between the first position and the second position in the first direction; and
identifying the projecting position of the focus target according to the difference, and
wherein the projecting controls the visible light irradiating device and the scanner to project the focus target at the projecting position.

3. The laser machining apparatus according to claim 2, wherein the controller is configured to further perform:
determining whether the projecting position falls within a process range in which machining with the laser beam is possible, the process range being defined in accordance with configuration of the optical member; and
in response to determining that the projecting position is out of the process range, notifying a user of probability of an error to be occurred while machining the workpiece with the laser beam.

4. The laser machining apparatus according to claim 1, further comprising a memory configured to store a plurality of pieces of position information in association with respective ones of a plurality of pieces of identification information, each of the plurality of pieces of position information specifying a projecting position of the focus target, each of the plurality of pieces of identification information identifying a machining process of the workpiece with the laser beam,
wherein the input device is further configured to receive the identification information,
wherein the controller is configured to further perform:
in response to receiving the input of the identification information, acquiring corresponding one of the plurality of pieces of position information in association with the identification information from the memory, and
wherein the projecting controls the visible light irradiating device and the scanner to project the focus target at the projecting position according to the corresponding one of the plurality of pieces of position information.

5. The laser machining apparatus according to claim 4, wherein the input device is further configured to receive workpiece information specifying constituent materials of the workpiece,
wherein the controller is configured to further perform setting a projecting size of the focus target according to the workpiece information, and
wherein the projecting controls the visible light irradiating device and the scanner to project the focus target in the projecting size.

6. The laser machining apparatus according to claim 3, wherein the optical member comprises a converging lens having a depth of field,
wherein the controller is configured to further perform:
determining whether the converging lens is replaced in the optical member; and
in response to determining that the converging lens is replaced, updating the process range in accordance with the depth of field of the replaced converging lens.

7. The laser machining apparatus according to claim 1, wherein the input device is further configured to receive an adjustment allowance for adjusting the focal position of the laser beam relative to the workpiece,
wherein the focus target includes a framing outline,
wherein the controller is configured to further perform setting a projecting position of the framing outline, and
wherein the projecting controls the visible light irradiating device and the scanner to project the focus target including the framing outline projected at the projecting position of the framing outline.

8. The laser machining apparatus according to claim 7, wherein the controller is configured to further perform:
setting whether to remove a removing portion from the focus target, the removing portion being a portion of the framing outline that can overlap the pointer beam, and
wherein the projecting controls the visible light irradiating device and the scanner to project the focus target including the framing outline in which the removing portion is removed.

9. The laser machining apparatus according to claim 1, wherein the input device is further configured to receive a defocusing amount specifying a projected position of the focus target on the mounting surface in the first direction,
wherein the controller is configured to further perform:
determining whether the input of the defocusing amount is received; and
in response to determining that the defocusing amount is received, modifying a shape of the framing outline in the focus target, and
wherein the projecting controls the visible light irradiating device and the scanner to project the focus target including the framing outline having a modified shape.

10. The laser machining apparatus according to claim 1, wherein the input device is further configured to receive an input indicating whether to project an optical focus guide,
wherein the controller is configured to further perform determining whether the input indicating to project the optical focus guide is received, and
wherein the projecting controls the visible light irradiating device and the scanner to further project the optical focus guide at a focused position of the laser beam on the workpiece.

11. A non-transitory computer readable storage medium storing a set of program instructions for a laser machining apparatus including: a laser beam emitting device configured to emit a laser beam for machining a workpiece disposed on a mounting surface perpendicular to a first direction; a scanner configured to scan the laser beam emitted from the laser beam emitting device; an optical member configured to converge the laser beam scanned by the scanner and maintain a focal point of the converged laser beam in a focal plane perpendicular to the first direction, the focal plane being located at a focal position in the first direction; a visible light irradiating device configured to irradiate a visible light in the first direction, thereby projecting a focus target on the workpiece; a pointer beam emitting device configured to emit a pointer beam toward the mounting surface at a prescribed inclination angle relative to the first direction, the pointer beam and the focus target being used for adjusting the focal position of the laser beam relative to the workpiece; an input device configured to receive position information related to a projecting position of one of the focus target and the pointer beam in the first direction; and a controller, the set of program instructions, when executed by the controller, causing the laser machining apparatus to perform:
modifying a positional relationship between the focus target and the pointer beam in a second direction perpendicular to the first direction according to the position information; and
projecting the focus target and the pointer beam onto the workpiece.
